(19) United States
(12) Patent Application Publication
(10) Pub. No.: US 2007/0273711 A1
(43) Pub. Date: Nov. 29, 2007

(54) 3D graphics system and method

(76) Inventor: Kenneth C. Maffei, Temecula, CA (US)

Correspondence Address: KENNETH MAFFEI, 30370 VIA BRISA, TEMECULA, CA, 92592, US

(21) Appl. No.: 11/541,955

(22) Filed: Oct. 2, 2006

Related U.S. Application Data
(60) Provisional application No. 60/737,853, filed on Nov. 17, 2005.

(51) Int. Cl. G06N 7/00

(52) U.S. Cl. 345/630; 345/583; 345/639

(57) ABSTRACT

A method of correcting bleed-through for layered three dimensional (3D) models is disclosed. A 3D body model and one or more 3D clothing items overlying the body model are provided, where the clothing items are layered. At least one slicer object is embedded in the clothing items. Inner layers of clothing that are visually occluded by outer layers of clothing are excluded from further processing, where occlusion is determined by complete encapsulation of an inner layer by an outer layer and when the outer layer slicer object(s) do not slice the inner layer. Areas of the underlying body model or underlying clothing items are removed via the slicer object(s). Clothing layers can be geometrically separated by expanding vertices on outer layers of clothing that intersect the geometry of inner layers of clothing, or by contracting vertices on inner layers of clothing that intersect the geometry of outer layers of clothing.

### CROSS-REFERENCE TO RELATED APPLICATIONS

This application claims the benefit of U.S. Provisional Application No. 60/737,853, filed Nov. 17, 2005, entitled “3D Graphic System and Method”, which is incorporated by reference.

### BACKGROUND OF THE INVENTION

1. Field of the Invention

The invention relates to three dimensional (3D) models, and more particularly, to customizing and animating computer-generated avatars having one or more layers of 3D clothing applied to the avatar.

2. Description of the Related Technology

Standard three dimensional (3D) models are typically comprised of a set of connected points in 3D space, commonly referred to as vertices. The points are connected in such a way that a polygonal mesh structure is formed. In the most generally case, the polygons can consist of any number of sides. The system herein assumes the polygons are all triangles. Note however, that since any planar polygon can be divided into a set of triangles, the current graphics process suffers no loss of generality.

### SUMMARY OF CERTAIN INVENTIVE ASPECTS

In one embodiment of the invention there is a method of correcting bleed-through for layered three dimensional (3D) models, the method comprising providing a 3D body model; providing one or more 3D clothing items overlying the body model, wherein the clothing items can be layered; and embedding at least one slicer object in the clothing items, wherein the slicer object removes areas of the underlying body model or underlying clothing items.

In another embodiment of the invention there is a method of changing three dimensional (3D) clothing models on a 3D body model so as to appear to be the original body model wearing new clothing, the method comprising providing one or more 3D clothing models for one or more parts of a 3D body model, slicing the body model based on the location of the clothing model(s), and displaying the sliced body model with the clothing model(s).

In another embodiment of the invention there is a method of testing for visual occlusion of layered three dimensional (3D) clothing models on a 3D body model, the method comprising providing one or more 3D clothing models overlying the body model, wherein the clothing models are layered, comparing a set of 3D geometric extents for an inner layer clothing model against a set of 3D geometric extents of an outermost layer clothing model, determining if one or more slicer polygons associated with the outermost layer clothing model intersect the inner layer clothing model if the inner layer clothing model is encapsulated by the outermost layer clothing model, and excluding further processing of the inner layer clothing model if none of the slicer polygons associated with the outermost layer clothing model intersect the inner layer clothing model.

In another embodiment of the invention there is a method of changing three dimensional (3D) clothing models on a deformed 3D body model so as to appear to be the deformed body model wearing new clothing, the method comprising deforming a 3D body model, storing the deformations of the body model, providing one or more 3D clothing models for one or more parts of the 3D body model, slicing an undeformed version of the body model based on the location of the clothing models, applying the stored deformations to the sliced body model and the clothing models, and displaying the deformed sliced body model with the clothing models. The deforming may utilize a system employing spatial influences. The system may comprise a bone system.

In another embodiment of the invention there is a method of deforming a three dimensional (3D) body model, the method comprising providing a set of bones for the 3D body model, wherein the body model comprises a set of vertices; assigning a weighting for each bone of the set of bones, wherein the weighting of a particular bone represents a spatial influence of the particular bone on a corresponding subset of the set of vertices; storing the weighting for each of the bones; obtaining an input for a deformation; changing an orientation of at least one bone in response to the input; and moving portions of the vertices corresponding to the at least one changed bone based on the stored weights so as to deform the body model.

The spatial influences may be dynamically calculated. A particular deformation may be modified by changing properties associated with one or more bones of the set of bones. One of the properties may comprise orientation. A new deformation may be added by adding a new set of bones for the new deformation. Obtaining an input for the deformation may be via a user interface. Bone orientation may comprise one or more of translation, rotation and scale.

In another embodiment of the invention there is a method of deforming hair of a three dimensional (3D) body model, the method comprising deforming a face of a 3D body model based on a user input, calculating a morph percentage of a possible total deformation of the face, providing a set of hair bones for deforming a hair model associated with the body model, and orienting the set of hair bones for the hair model corresponding to the morph percentage. The hair model may comprise a set of vertices. The method may additionally comprise assigning a weighting for each bone of the set of hair bones, wherein the weighting of a particular bone represents a spatial influence of the particular bone on a corresponding subset of the set of vertices. Deforming the hair model may match the hair model to a shape of the deformed face.

In another embodiment of the invention there is a method of deforming hair of a three dimensional (3D) body model, the method comprising providing at least one 3D clothing model for a 3D body model, wherein at least a portion of the at least one clothing model comprises a set of bones; determining an outermost clothing model on the torso of the body model; adding a hair deformer for a hair model associated with the body model if the outermost clothing model includes a set of bones; and applying the hair deformer to move the hair model based on the outermost clothing model. Applying the hair deformer may comprise orienting hair bones corresponding to the hair deformer. Applying the hair deformer may comprise preventing intersection of the hair model and the outermost clothing model by moving the hair model. The hair bones may comprise at least one bone behind the neck and shoulders of the body model, at least one bone in front of the right shoulder, at least one bone in front of the left shoulder, and at least one bone along the top of the shoulders.

In another embodiment of the invention there is a method of changing a skin tone of a three dimensional (3D) body model, the method comprising providing a 3D body model having a texture map including pixels having color, wherein a base texture map has a base skin tone color average; obtaining a requested skin tone color; calculating a difference between the requested skin tone color and the base skin tone color average; weighting the difference, for each pixel in the texture map, by a distance in color space between a color of a pixel and the base skin tone color average; and applying the weighted difference to each pixel in the texture map.

The weighting may comprise:
1.0−((Red_{new}−Red_{original})**2+(Green_{new}−Green_{original})**2+(Blue_{original}−Blue_{original})**2)/normalizer,
where the normalizer is a distance of the pixel color to a point in color space that is farthest from the base skin tone color average. Obtaining the requested skin tone color may be based on a user input. The difference may be additionally weighted by a distance to pure white in color space so as to preserve highlights. The additional weighting may comprise:
1.0−(((2^{N}−1)−Red_{original})**2+(2^{N}−1)−Green_{original)**}2+((2^{N}−1)−Blue_{original})**2)/normalization factor,
where N is the number of bits representing one of red, green or blue and the normalization factor is equal to the distance from pure black to pure white in color space. The normalization factor may be 195075. Each pixel may have 24 bit color.

In another embodiment of the invention there is a method of animating an eye blink for a three dimensional (3D) body model, the method comprising a) generating an eye blink animation for a morph target of a deformed eye shape feature of an eye model for a 3D body model, wherein the morph target is an extreme limit of a particular deformation; b) determining a weight based on a percentage of deformation to the morph target for the deformed eye shape feature; and c) assigning the weight to the eye blink animation of the eye shape feature.

The method may additionally comprise providing an eye blink animation for an undeformed eye model of the 3D body model, generating an eye blink animation for the undeformed eye model, and deforming an eye shape feature of the eye model in response to a user input. The method may additionally comprise repeating a) through c) for any additional eye shape features selected by the user for deforming and blending the eye blink animation for the undeformed eye model with the eye blink animation of the deformed eye shape feature(s) in accordance with the weights to generate a combined eye blink animation. The method may additionally comprise preventing either a right eye or a left eye from blinking so as to produce a wink animation. The preventing may additionally comprise designating a time from a start of a facial animation for the wink animation to occur. The deforming of an eye shape feature may include one of a rotating, scaling and general eye socket shape changing.

In another embodiment of the invention there is a method of correcting bleed-through for layered three dimensional (3D) models, the method comprising providing a 3D body model; providing one or more 3D clothing items overlying the body model, wherein the clothing items are layered; embedding at least one slicer object in the clothing items; excluding from further processing inner layers of clothing that are visually occluded by outer layers of clothing, wherein occlusion is determined by complete encapsulation of an inner layer by an outer layer and when the outer layer slicer object(s) do not slice the inner layer; and removing areas of the underlying body model or underlying clothing items via the slicer object(s).

In another embodiment of the invention there is a method of correcting bleed-through for layered three dimensional (3D) models, the method comprising providing a 3D body model; providing one or more 3D clothing items overlying the body model, wherein the clothing items are layered and comprises vertices; embedding at least one slicer object in the clothing items; excluding from further processing inner layers of clothing that are visually occluded by outer layers of clothing, wherein occlusion is determined by complete encapsulation of an inner layer by an outer layer and when the outer layer slicer objects(s) do not slice the inner layer; geometrically separating clothing layers by contracting vertices on inner layers of clothing that intersect the geometry of outer layers of clothing; geometrically separating clothing layers by expanding vertices on outer layers of clothing that intersect the geometry of inner layers of clothing; and removing areas of the underlying body model or underlying clothing items via the slicer object(s).

In another embodiment of the invention there is a method of changing three dimensional (3D) clothing models on a deformed 3D body model so as to appear to be the deformed body model wearing new clothing, the method comprising deforming a 3D body model; storing the deformations of the body model; providing one or more 3D clothing models for one or more parts of the 3D body model, wherein at least one slicer object is embedded in each of the clothing models; excluding from further processing inner layers of clothing that are visually occluded by outer layers of clothing, wherein occlusion is determined by complete encapsulation of an inner layer by an outer layer and when the outer layer slicer object(s) do not slice the inner layer; geometrically separating clothing layers by contracting vertices on inner layers of clothing that intersect the geometry of outer layers of clothing; geometrically separating clothing layers by expanding vertices on outer layers of clothing that intersect the geometry of inner layers of clothing; slicing an undeformed version of the body model based on the location of the clothing models; slicing inner layers of undeformed clothing with outer layer slicer object(s) based on the location of the clothing models; applying the stored deformations to the sliced body model and the clothing models; and displaying the deformed sliced body model with the deformed clothing models. The deforming may utilize a bones structure.

In another embodiment of the invention there is a method of resolving intersections for layered three dimensional (3D) models, the method comprising providing a 3D body model; providing 3D clothing items overlying the body model, wherein the clothing items are layered and comprise vertices; geometrically separating clothing layers by expanding vertices on outer layers of clothing that intersect the geometry of inner layers of clothing; geometrically separating clothing layers by adjusting vertices on outer layers of clothing to be at least a threshold distance from the geometry of inner layers of clothing; and geometrically separating clothing layers by contracting vertices on inner layers of clothing that intersect the geometry of outer layers of clothing. The method may additionally comprise animating the 3D body model with the geometrically separated clothing layers, whereby bleed-through of the inner layers of clothing is substantially prevented during the animation.

In another embodiment of the invention there is a method of resolving intersections for layered three dimensional (3D) models, the method comprising providing a 3D body model; providing one or more 3D clothing items overlying the body model, wherein the clothing items are layered and comprises vertices; geometrically separating clothing layers by expanding vertices on an outer layer of clothing that intersect the geometry of an inner layer of clothing; geometrically separating clothing layers by adjusting vertices on the outer layer of clothing to be at least a threshold distance from the geometry of the inner layer of clothing; and geometrically separating clothing layers by contracting vertices on the inner layer of clothing that intersect the geometry of the outer layer of clothing. The method may additionally comprise animating the 3D body model with the geometrically separated clothing layers, whereby bleed-through of the inner layer of clothing is prevented during the animation. Geometrically separating clothing layers by expanding vertices on the outer layer of clothing may comprise expanding the outer layer; for each vertex on the outer layer, generating a line segment from the current vertex on the expanded outer layer to the original outer layer, determining if the line segment intersects any polygons on the inner layer, and moving the current vertex of the original outer layer to a position outside of the intersected polygon if the line segment intersects any polygons. Geometrically separating clothing layers by adjusting vertices on the outer layer of clothing may comprise for each vertex on the outer layer, generating a line segment from the current vertex on the outer layer to another position, identifying which polygon on the inner layer is intersected by the line segment, and adjusting the current vertex of the outer layer to be at least a threshold distance from the identified polygon if the distance of the outer layer vertex to the identified polygon is less than the threshold distance. The method may additionally comprise contracting the outer layer so as to move at least a portion of the outer layer in a direction substantially orthogonal to the surface of the 3D body model. Geometrically separating clothing layers by contracting vertices on the inner layer of clothing may comprise contracting the inner layer; for each vertex on the inner layer, generating a line segment from the current vertex on the contracted inner layer to the original inner layer, determining if the line segment intersects any polygons on the outer layer, and moving the current vertex of the original inner layer to a position inside of the intersected polygon if the line segment intersects any polygons.

In yet another embodiment of the invention there is a method of resolving intersections for layered three dimensional (3D) models, the method comprising providing a 3D) body model; providing one or more 3D clothing items overlying the body model, wherein the clothing items are layered and comprises vertices; geometrically separating clothing layers by expanding vertices on an outer layer of clothing that intersect the geometry of an inner layer of clothing and by contracting vertices on the inner layer of clothing that intersect the geometry of the outer layer of clothing.

### BRIEF DESCRIPTION OF THE DRAWINGS

FIG. 1 is a diagram of an exemplary distributed computer network on which an embodiment of a three dimensional (3D) graphics system operates.

FIG. 2 is a block diagram of an exemplary embodiment of a virtual gaming environment system that operates on the computer network shown in FIG. 1.

FIG. 3 is a flowchart of an exemplary game loop embodiment for the graphics system shown in FIG. 2.

FIG. 4A is a diagram of an exemplary 3D facial model diagrammed using geometric data as used by the graphics system.

FIG. 4B is a diagram of an exemplary 3D body model and multiple clothing models shown separately and displayed with the clothing models overlying the body model.

FIG. 5 is a flowchart of an exemplary model preparation process shown in FIG. 3.

FIG. 6 is a diagram showing an exemplary 3D shirt clothing model having slicer objects as used by the graphics system.

FIG. 7 is a diagram of a portion of an exemplary nude body model in the collar region of a shirt.

FIG. 8 is a diagram of a portion of the exemplary nude body model shown in FIG. 7 after a slicer object has been applied.

FIG. 9 is a diagram of a portion of an exemplary nude body model after application of the slicer objects associated with the shirt model shown in FIG. 6.

FIG. 10 is a diagram of a portion of the exemplary body model shown in FIG. 9 with a texture map applied.

FIG. 11 is a diagram of a portion of the exemplary textured body model shown in FIG. 10 rendered together with the shirt model.

FIG. 12 is a diagram of an exemplary body model wearing a coat layered over a shirt.

FIG. 13 is a diagram of exemplary bounding boxes for the geometries of the shirt and coat of the body model shown in FIG. 12, such as used during an exclusion process of the graphics system.

FIG. 14 is a diagram of an exemplary coat model having a slicer object that intersects an underlying shirt model.

FIG. 15 is a flowchart of an exemplary clothes layering for legs process shown in FIG. 5.

FIG. 16 is a flowchart of an exemplary clothes layering for torso process shown in FIG. 5.

FIG. 17 is a flowchart of an exemplary clothes slicing process shown in FIG. 5.

FIG. 18 is a flowchart of an exemplary deformer system process shown in FIG. 5.

FIG. 19 is a diagram of an exemplary 3D nude body model showing a neutral orientation of bones for deforming the hips.

FIG. 20 is a diagram of the exemplary body model of FIG. 19 showing a deformed orientation of the bones for the hips.

FIG. 21 is a diagram of an exemplary 3D body model wearing a conforming bikini top as an example of the results of a chest/bust deformer.

FIG. 22 is a diagram of an exemplary 3D body model wearing a non-ater conforming sweater as another example of the results of the chest/bust deformer.

FIG. 23 is a flowchart of an exemplary eye blink system process shown in FIG. 18.

FIG. 24 is a flowchart of an exemplary torso clothing hair deformer process shown in FIG. 5.

FIG. 25 is a flowchart of an exemplary face shape hair deformer process shown in FIG. 5.

FIG. 26 is a flowchart of an exemplary clothing occlusion process shown in FIG. 5.

FIG. 27 is a pseudo code listing of an exemplary skin tone system process shown in FIG. 5.

FIG. 28 is a flowchart of an exemplary body model slicing process shown in FIG. 5.

FIG. 29 is a flowchart of an exemplary bones deformer process shown in FIG. 5.

FIG. 30 is a diagram of five views A, B, C, D and E showing an example use of the hair bones system where hair is moved to accommodate clothing of a 3D body model.

FIG. 31 is a diagram of three views A, B and C showing an example of intersection resolution of a 3D body model.

FIG. 32 is a diagram of original and expanded wireframe meshes for clothing items covering the torso and legs to illustrate an example of clothes scaling.

FIGS. 33 and 33B are a flowchart of an exemplary intersection resolution process shown in FIGS. 15 and 16.

### DETAILED DESCRIPTION OF CERTAIN EMBODIMENTS

The following detailed description of certain embodiments presents various descriptions of specific embodiments of the invention. However, the invention can be embodied in a multitude of different ways as defined and covered by the claims. In this description, reference is made to the drawings wherein like parts are designated with like numerals throughout.

The terminology used in the description presented herein is not intended to be interpreted in any limited or restrictive manner, simply because it is being utilized in conjunction with a detailed description of certain specific embodiments of the invention. Furthermore, embodiments of the invention may include several novel features, no single one of which is solely responsible for its desirable attributes or which is essential to practicing the inventions herein described.

The system is comprised of various modules, tools, and applications as discussed in detail below. As can be appreciated by one of ordinary skill in the art, each of the modules may comprise various sub-routines, procedures, definitional statements and macros. Each of the modules are typically separately compiled and linked into a single executable program. Therefore, the following description of each of the modules is used for convenience to describe the functionality of the preferred system. Thus, the processes that are undergone by each of the modules may be arbitrarily redistributed to one of the other modules, combined together in a single module, or made available in, for example, a shareable dynamic link library.

The system modules, tools, and applications may be written in any programming language such as, for example, C, C++, BASIC, Visual Basic, Pascal, Ada, Java, HTML, XML, or FORTRAN, and executed on an operating system, such as variants of Windows, Macintosh, UNIX, Linux, VxWorks, or other operating system. C, C++, BASIC, Visual Basic, Pascal, Ada, Java, HTML, XML and FORTRAN are industry standard programming languages for which many commercial compilers can be used to create executable code.

A. Introduction

1. Overview

A unique set of processes for implementing a user-customizable computer-generated avatar are described. Customization takes the form of changing the facial structure, body structure, hair, and clothing of the avatar. The customized model can then be animated using standard graphics techniques. The processes defined herein are not dependant upon any particular application or user interface to perform their operations. Also, the processes act upon standard three-dimensional (3D) models constructed using widespread 3D graphics techniques. The techniques of the processes are not limited to human avatars. They may be applied to any type of character, monster, humanoid, animal or other creature. Additionally, the techniques may be applied to other situations such as furniture coverings, draperies, or any other scenario where material such as cloth, armor, etc. is layered over an arbitrary 3D model.

2. System Overview

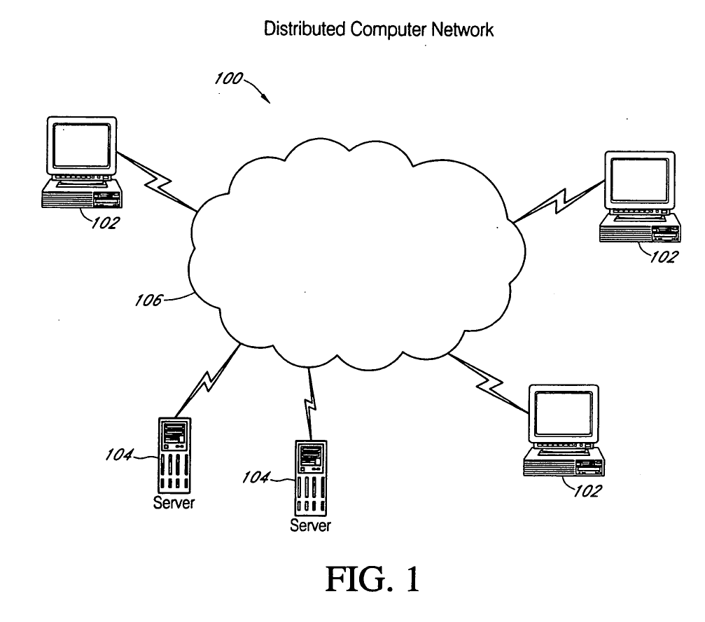

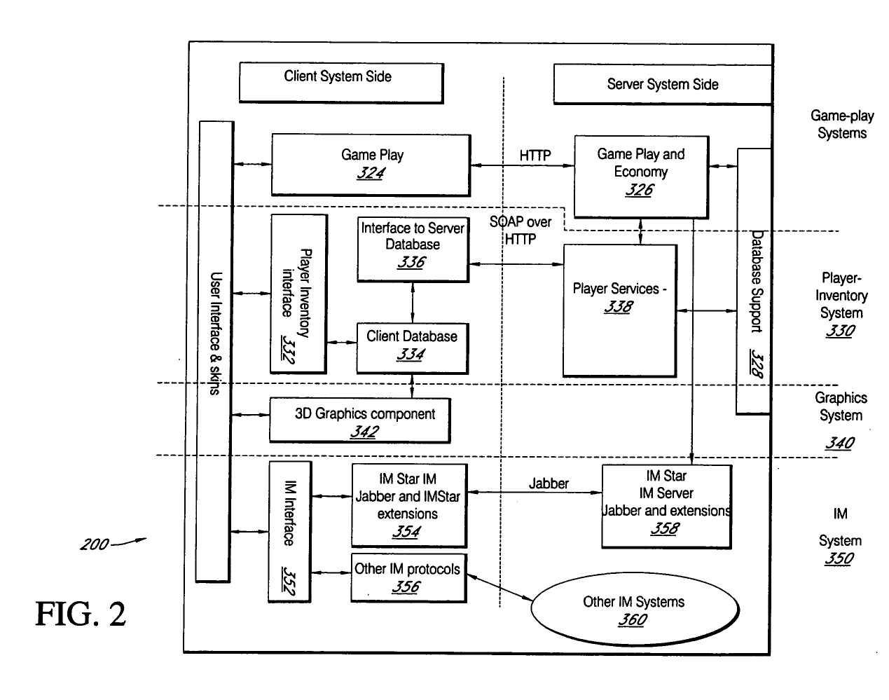

A 3D graphics system 340 is a portion of an example system 200 shown in FIG. 2 for a role-playing game having a customizable avatar that operates on an example computer network 100 shown in FIG. 1. The computer network 100 includes user computers 102, one or more servers 104 and a network 106, such as an intranet or the Internet. The system 200 and network 100 are described in U.S. Patent Publication No. 2005/0137015, entitled Systems and Methods for a Role-Playing Game Having a Customizable Avatar and Differentiated Instant Messaging Environment, which is hereby incorporated by reference.

3. Bleed-Through Problem

The unique 3D graphics system and method allows participants to change their avatar's clothes and wear multiple layers of clothing by constructing a new avatar consisting of multiple models including the basic nude model and all of its parts, all the clothing models, and hair models and any other models that might be required.

Displaying multiple models at one time results in having to render too many polygons and often produces the visual problem of bleed-through. A common difficulty in real-time graphics applications, known as bleed-through, occurs when processing polygons that overlap or are very close to each other. The problem manifests itself as displaying the wrong polygon to the viewer. The present 3D graphics process advantageously minimizes the polygon count and removes underlying layers so that a computer's graphic system does not try to render two or more sets of polygons over each other. To accomplish this, the system makes use of processes described as “layering”, “occlusion/exclusion”, and “slicing”. This terminology will become clear in the discussions that follow. These processes are performed with the avatar wearing several layers of clothing at one time. The techniques employed for layering and slicing are valid for other situations including, but not limited to characters, monsters, humanoids, animals or other creatures, furniture coverings, draperies, or any other scenario where material such as cloth, armor, etc. is layered over an arbitrary 3D model.

Specifically, before the avatar can be rendered and displayed wearing a set of clothing items, the nude body model and underlying clothing layers must have geometry, and sections of geometry, removed. Two serious problems are encountered in the absence of this act. First, the number of polygons being sent to the graphics card becomes unmanageably high. Second, bleed-through of layered polygons, which include the body and clothing layers, from both quantum z-buffer errors and imprecise skin weighting on the vertices, produces unacceptable visual anomalies. Z-buffer errors are caused by the fact that the graphics card quantizes the depth of field of the 3D space. As such, overlapping triangles that are extremely close to each other can both be placed within the same bin. Depending upon implementation, the graphics card may choose to render the triangle that is actually further away from the viewer. The viewer perceives this as bleed-through, where the geometry that should be covered is actually seen.

Skin weighting errors arise from the imprecise nature of how 3D objects are constructed for animation. Skin weighting refers to the process that 3D modelers and animators employ to create animatable 3D objects. The vertices are attached to an underlying skeletal stricture which causes the vertices to move with the skeleton as the skeleton is animated. The vertices in this process are referred to as the “skin”, and blending of influences from the bones within the skeletal structure is known as “skin weighting”. This is a 3D graphics procedure and is used to animate the avatar in this system. Because clothing objects are independently designed by 3D artists, how the geometry of a given piece of clothing moves under animation is not pre-conformed to other articles of clothing. Therefore, under animation, vertices of an inner layer of clothing may move slightly outside of an outer layer of clothing. Equivalently, vertices of clothing next to, and very close to the avatar's body, may move slightly inside the body. The result of such effects is again bleed-through.

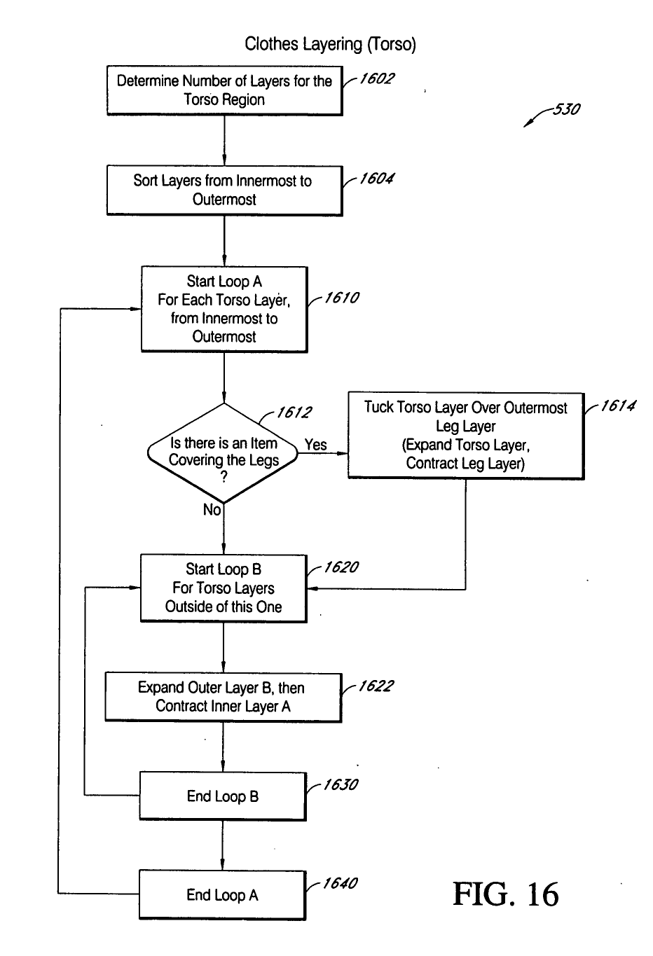

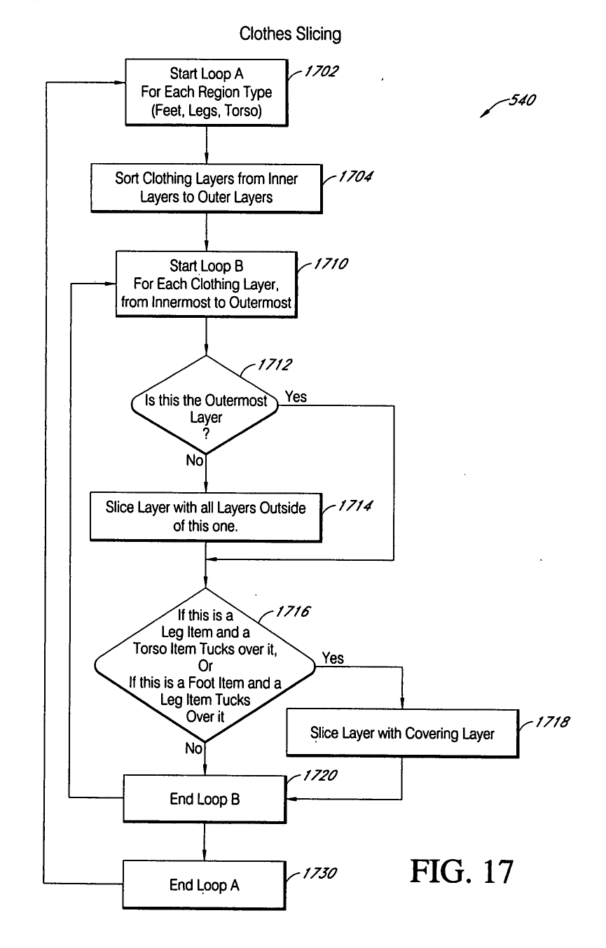

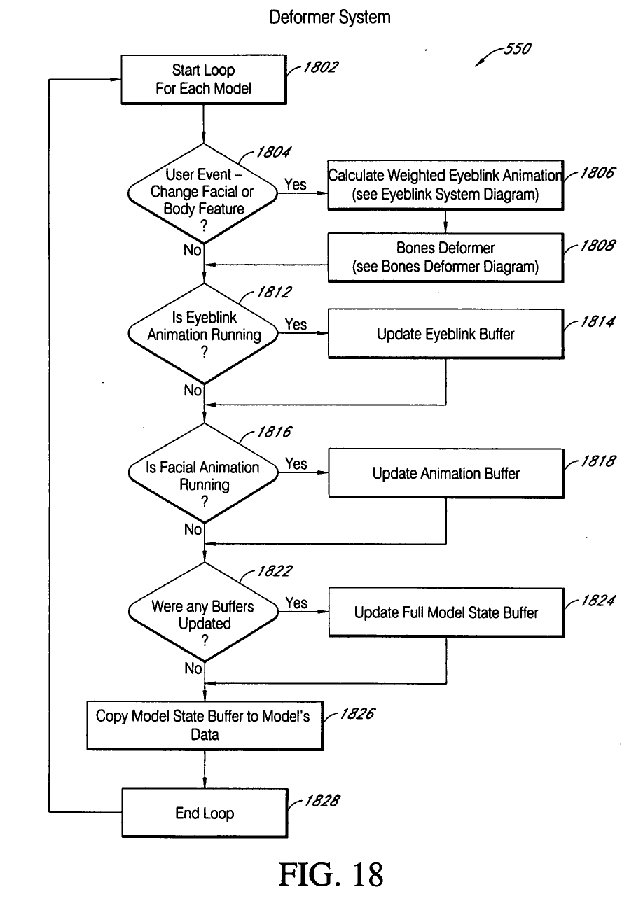

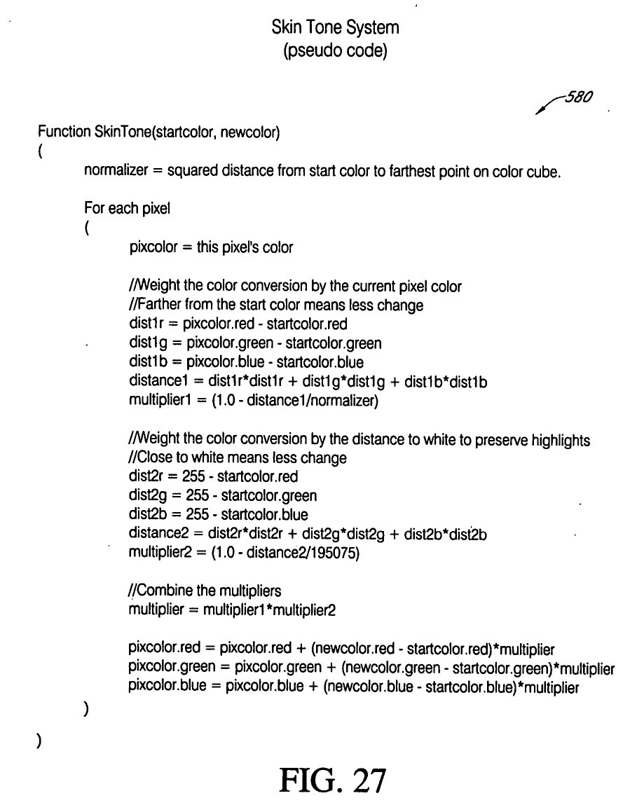

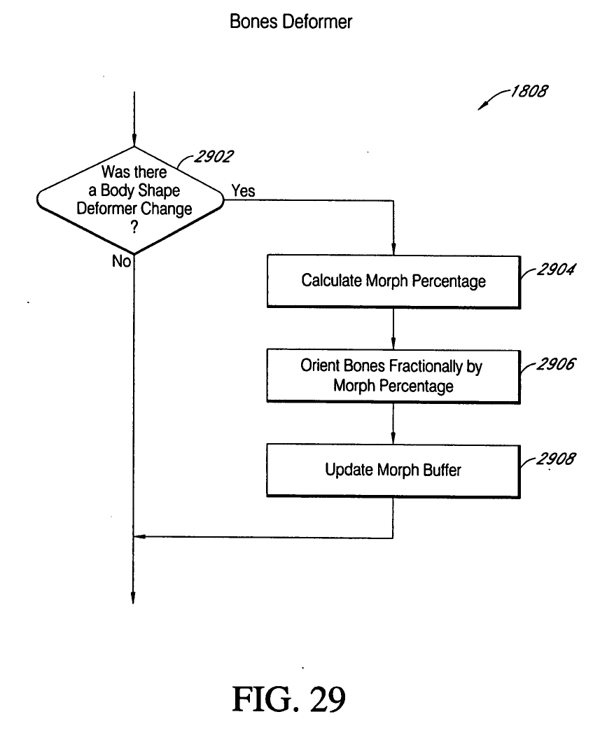

To eliminate bleed-through, the system makes use of processes described as “layering”, “occlusion/exclusion”, and “slicing”. These processes are performed with the avatar wearing several layers of clothing at one time. Slicing is described in section B(2), Model Slicing, and section B(3)(iv), Body Slicing. A Body Model Slicing process is diagrammed by process 544 of FIG. 28. Clothes Slicing is described in section B(3)(iii) and process 540 of FIG. 17. Layering is discussed in section B(3)(ii), Clothes Layering, and diagrammed in processes 520, 530 of FIGS. 15 and 16. Occlusion/Exclusion is described in section B(3)(i) Exclusion Testing and diagrammed in process 510 of FIG. 26.

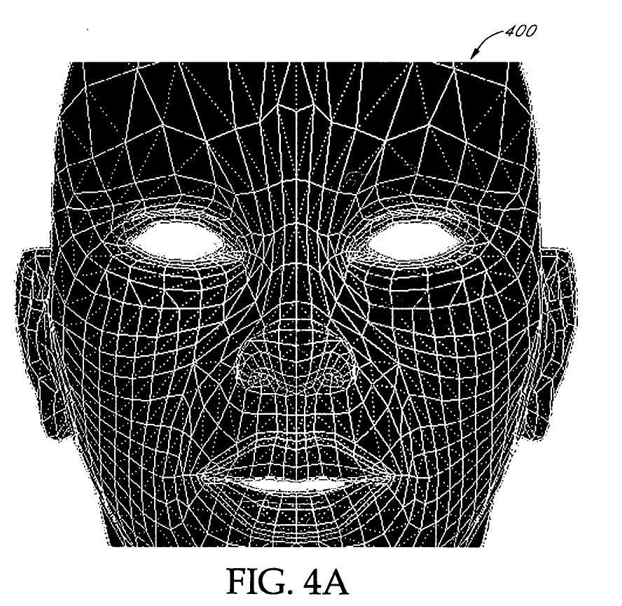

FIG. 4B is diagram exemplary of an avatar wearing clothes. A nude model 420 is shown in the upper left-hand corner, followed by a t-shirt 430, sweater 440, jeans 450 and running shoes 460. The lower right-hand corner displays the avatar with the clothes applied 470. Note that the sweater is layered over the t-shirt, and that both the t-shirt and sweater layer over the pants (a process termed “tucking out”). The clothed avatar exhibits no bleedthrough since the slicing and layering processes described herein have been applied.

4. Deformations

Additionally, the 3-D graphics process includes several novel deformation systems. In these deformation systems the avatar, clothing and hair are deformed by the influence of strategically placed geometric objects, referred to as bones. As explained in greater detail herein, these geometric objects, or bones, define a spatial influence function that affects vertices near the objects. Therefore, the avatar vertices, clothing vertices and hair vertices fall under the influence of these objects. As the bone objects move, rotate, or scale, the surrounding avatar, clothing and hair vertices also move in proportion to the influence. As such, both the body and clothing behave in the same manner during deformation. The appearance to the participant is that as they change the avatar's features, the clothes automatically conform to the avatar's body, and hair automatically conforms to the clothing and face shape. The use of bones to cause a 3D model to animate, where the form of the model does not change, is a common technique. The present system uses bone objects to affect deformations of the model that change the form of the model.

5. Additional Processes

Along with changing the avatar's features, clothing and hair, the avatar's skin color may also be varied by the user. The system changes skin tone by shifting the average color in the avatar's texture map. This is done while preserving shadows and highlights on the skin. Makeup can be added to the avatar by blending a semi-transparent texture map to the underlying skin texture.

The 3D graphics process also includes a facility to allow the avatar to wear high heel shoes. High heel shoes require that the avatar perform a motion that raises it up on its toes. The process also adjusts the overall height of the avatar above the ground plane, so the shoes remain planted on the ground. The effect of the high heels is mixed with any other animations the avatar is performing.

6. Data Preparation and Rendering

A computer's graphics system displays information on a computer monitor by periodically updating the screen. The rate at which this update takes place is called the “frame rate.” For each update, or frame, a sequence of processes takes place in order to prepare and transmit 3D data for visual presentation. In the 3D graphics system, there are three stages associated with presenting 3D data. The first and second stages are directed to the preparation of the 3D data while the third stage is associated with the displaying (or rendering) the prepared data on the computer monitor. The third stage may use any number of available software and system products to render these images. For example DirectX libraries or OpenGL may be used to send the 3D data, prepared in the first and second stages described herein, to a graphics card for processing and subsequent display on a screen. As such, the third stage of the graphics process uses display and rendering techniques common to numerous existing 3D applications.

The data preparation processes that may occur before a complete avatar is rendered may be initiated in many ways. These processes may be software triggered or event-driven, that is, spawned by user interaction. An example of software triggering would be the initial loading of the avatar from disk, where the avatar becomes fully clothed without any user interaction. Another example might be the generation of pre-defined, modified and clothed avatars in response to specific selections made by a user. Yet another example might be the generation of a modified and clothed avatar in response to a request from a remote server or network resource. For illustrative purposes, and without loss of generality, a typical embodiment of the graphics process is considered herein. In this embodiment, the elements that comprise the graphics process can be embedded in a software loop that will be referred to as a “game loop”. This terminology is standard for 3D games in the graphics industry. The algorithms developed for the current graphics process are independent of the embodiment that employs them.

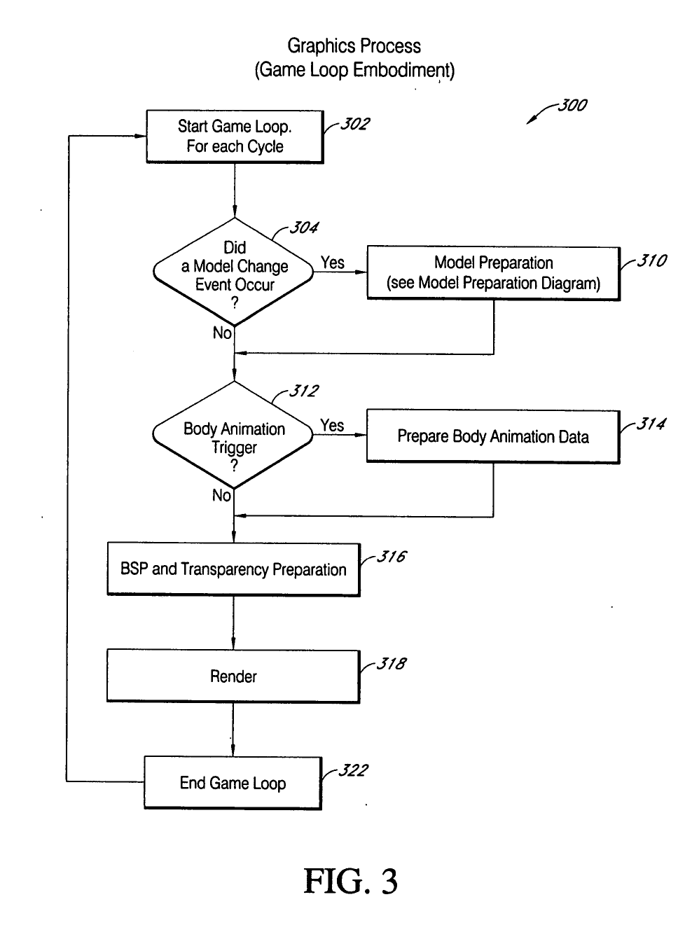

In a game loop embodiment, such as shown in FIG. 3, the loop executes once for each frame. It performs checks to determine if any triggered processes are to run, and to also run those processes that must be performed for each frame, therefore many times per second. Processes that are performed each and every frame are termed “recurring”. The game loop checks for triggered or event-driven processes before any other processes are invoked. Event-driven data preparation is triggered when the participant invokes certain actions, including but not limited to, placing or changing clothes on the avatar and modifying the avatar's facial or body features using a user interface element, such as a slider or button. When any of these actions are performed, the underlying 3D data is changed until the user performs this action or a similar action again. Depending upon the action, processes may be performed on any or all of the 3D models that make up the avatar. These models can include, but are not limited to, the basic nude model, each separate clothing item, and the hair currently being worn by the avatar.

For example, a user may wish to clothe the avatar in a halter-top, shorts and shoes. The user initiates the event-driven processes that perform this action by means of some user-interface element such as a button or hyperlink. In certain embodiments, the resultant, conglomerate avatar includes eight separate but coordinated 3D models that are processed (e.g., body, eyes, mouth, hair, eyelashes, halter, shorts, and shoes). In certain embodiments, the event-driven data preparation processes include 1) preparation of the body, slicing it for the appropriate clothes, slicing of underlying clothes layers by outer clothes layers, tucking shirts outside of pants and pants outside of shoes, applying deformation parameters, 2) preparation of the eyes (facial deformations), 3) preparation of the mouth (facial deformations), 4) preparation of the clothing (body deformations), 5) preparation of the hair (facial deformation, deformation to move hair away from clothing, and preparation of binary space partition (BSP) transparency data structures), and 6) preparation of the eyelashes. The resulting data is then stored in various buffers to be used by recurring processes in the game loop. Each of these event-driven processes is described in greater detail herein below.

Recurring data preparation, on the other hand, includes data preparation that is required for every frame including, but not limited to, animating the avatar when indicated by the participant. Recurring data preparation occurs after such checking for any changes in the avatar generated by the event-driven processes. During recurring data preparation, in certain embodiments, the model undergoes the following processes for each frame: 1) applying or modifying a buffer of facial and body morphs maintained in the deformer system which gives the avatar the customized look, 2) facial animation via the deformer system, 3) body animation via the body animation system, 4) rendering preparation and BSP processing and 5) rendering. It is important to note that the order of rendering objects is important for transparency purposes. Those items that are not transparent are rendered first and include the body, eyes and mouth. Those items that may contain transparency are rendered next. For example, hair will be rendered after the clothing because hair often covers the clothing and has transparent aspects. Similarly, the eyelashes will be processed after the hair because at certain angles, the eyelashes may overlay the hair.

3D data includes geometric data, texture data, animation data, and auxiliary data specific to the requirements of the graphics process described herein. In certain embodiments, the geometric, texture and animation data formats are standard industry formats. For example, geometric data is stored as a set of connected triangles. FIG. 4A is an exemplary illustration of a model diagrammed using geometric data. As illustrated, the facial model 400 is made up of a set of connected triangles. In certain embodiments, each model in the graphics processing system is constructed in this manner.

Texture map data may be stored in a conventional bitmap image format including but not limited to a .jpg, .bmp, .tga, or other standard file formats. In certain embodiments, texture data consists of a colored planar drawing wherein each vertex of the model is mapped to a specific point on the drawing and given that particular color. Graphics cards are responsible for interpolating the texture data between vertices (e.g., across triangles) as part of the rendering process, thus producing a continuous mapping of the texture over the model. A texture map has been applied to the facial model shown in FIG. 4A as illustrated by the color texture. Each model may be associated with at least one texture file. Furthermore, standard animation data formats may be used to make the avatar move. These may be, but are not limited to, bones animation systems and vertex animations systems.

In addition to these data formats, the graphic process described here also utilizes unique data formats including but not limited to: 1) morph target data used to deform the face in response to the participant moving a slider, 2) facial animation data used for facial animations, 3) body deformation data which allows clothing to be deformed along with the body, 4) slicer data for defining where the nude 3D model and underlying clothing layers should be “cut” in order to remove triangles and 5) transparency data that enables proper display of items that exhibit transparent or semi-transparent qualities.

B. Game Loop Processing

1. Overview

By way of example, the graphics process may be embedded in a software loop henceforth referred to as a game loop. Referring to FIG. 3, as described herein, a game loop embodiment 300 of the graphics process consists of a single loop 302 in certain embodiments. The loop enters decision state 304, checking for any event-driven data preparation to be done at model preparation process 310, which may be triggered when the participant invokes certain actions such as placing or changing clothes on the avatar. Event-driven processes may involve clothing changes (including hair), changing the avatar's skin tone, adding makeup, or deforming the avatar's facial or body features. Following any event-driven processes, the game loop's recurring processes are performed starting at decision state 312. These processes are those which specifically prepare the 3D data for rendering by the computer's graphics subsystem. Other embodiments utilizing the changing of clothes, skin tone, makeup and deformations as described herein are possible. For example, the event driven processes need not occur in a game loop process at all. Note that in this description, standard 3D graphics rendering elements such as cameras and lighting will not be discussed, as they are common to any graphics rendering system.

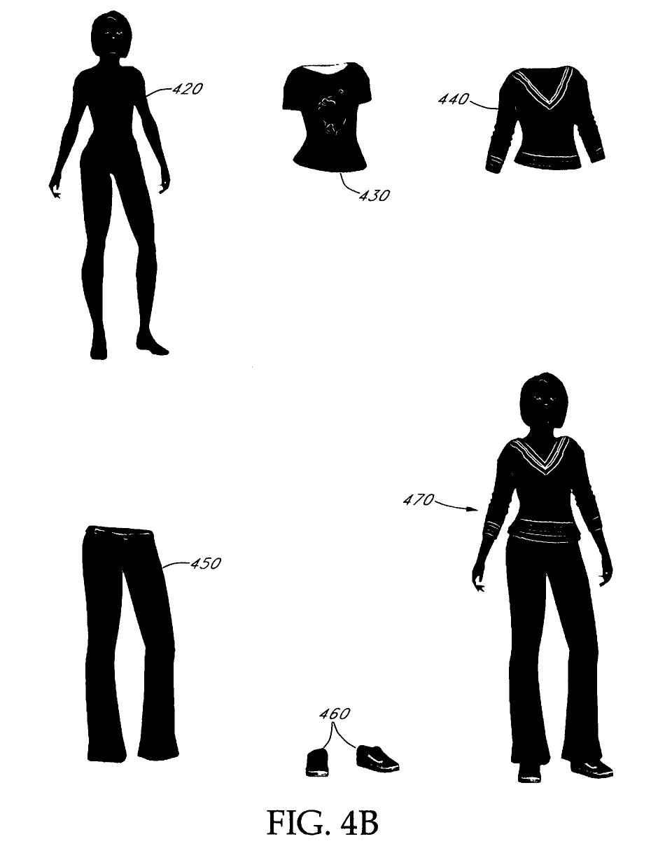

The model preparation process 310 is invoked when the avatar's clothing is changed. Referring to FIG. 5, raw model data is read from disk at state 502 of process 310. The raw data contains the original, unaltered geometric and texture data, as well as the models' skeletal data for the nude model and all clothing models. The first act in applying clothing to the nude model is to check if any clothing is completely obscured by any other clothing. This process is called Clothing Occlusion/Exclusion and is indicated by process 510. For example, a T-shirt may be completely occluded by a large sweater. If this is the case, the T-shirt can be safely omitted from the clothes processing and rendering stages since the user would never see it. Following clothing occlusion, process 310 proceeds to states 512, process 520 and process 530. Here clothes are layered onto the avatar from the feet upwards. Clothes that cover the feet are layered in state 512. Next process 310 advances to process 520 where clothes that cover the legs are layered, and then to process 530 where clothes that cover the torso are layered. The layering process involves making sure that inner layers are completely contained within outer layers, and that no geometric intersections are present between layers that cover a given region of the body. Layering also includes a facility to ensure pants are tucked out of shoes and shirts are tucked out of pants without intersection. Once all clothing is layered, process 310 advances to process 540 and then process 544, where removal of unnecessary geometry is performed. The reasons for this are detailed below. Removal of unnecessary geometry occurs by having outer clothing layers remove unseen inner clothing geometry beneath them in Clothes Slicing process 540, and by having all clothing remove unseen geometry from the avatar's body in Body Model Slicing process 544. This action performed in these two states is termed “slicing”.

Once all of the above acts are completed, the system advances to process 550, where the process applies physical deformations to the nude model and to all of the remaining clothing items. As one or more pieces of clothing will always cover any geometry (body or clothing) that was removed in the slicing stage, the avatar now has the appearance of being dressed. At state 550 physical deformations are applied to what is left of the nude model and clothing models to give the impression that the clothes deform with the underlying body model. Additionally, other deformers that move the hair away from the face and away from clothing that covers the torso are applied. The above acts are discussed in more detail below. Proceeding to process 560, a system which deforms hair in response to changes in face shape is applied. These face shapes are part of the deformer system 550 and are those deformers that effect a global change in the dimensions of the face. Then at process 570, a system which deforms long hair so it may conform to clothing is applied. This is necessary as items such as thick sweaters or jackets must push the hair away so that it does not intersect with the clothing. At process 580 the nude model may have its texture modified to change the model's skin tone color. Finally, at state 585 the model can be subjected to an animation that raises it up on its toes if the model is wearing high heels.

2. Model Slicing

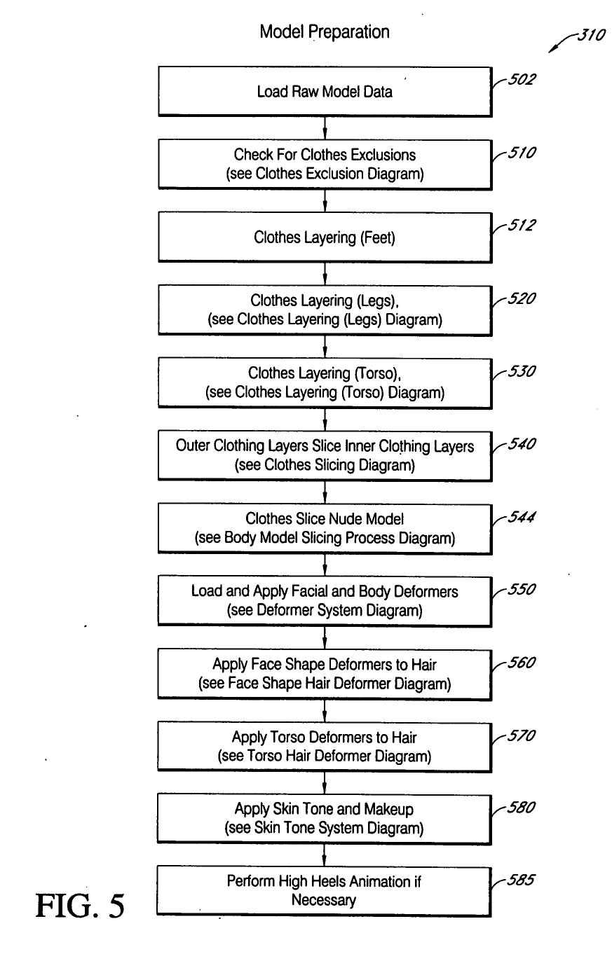

To assist in overcoming the bleed-through problem as discussed in section 3 of the Introduction, each clothing object contains auxiliary non-renderable geometry called “slicers.” These slicers are simple geometric objects, in many cases just single triangles or rectangles, although any appropriate object may be used. The slicers are placed at strategic places with respect to the object, such as the ends of sleeves of a shirt, around collars, or at the tops of the shoes. By way of example, consider the slicing of the body model by the first layer of clothing. The slicers serve as knife edges that intersect the avatar's body. FIG. 6 is an exemplary illustration 600 of slicer objects positioned around points of a shirt 605. Specifically, the slicers are used to define regions of geometry on the body that can be safely removed, as the overlying clothing will cover those areas and they will not be seen. A slicer is a mathematical description of an object that uses standard 3D geometric data. The graphics process computes where these slicers intersect an underlying model. Intersection is defined as the place where the slicer polygons intersect body polygons. This is similar to computing where two planes intersect. Where polygons are intersected, they are divided by the slicer. In FIG. 6, four slicer objects are indicated by the collar slicer 610, the arm slicers 620 and 622, and the waist slicer 630. The slicers effectively cap the holes in the shirt's geometry, thus defining a bounded region where underlying polygons may be removed.

Because clothing shape varies, it is not practical to create a system that will slice cleanly on body triangle edge boundaries. Furthermore, the system does not assume that the underlying body model is constructed in any particular way. Therefore, the slicers assume nothing and actually cut through the body triangles at arbitrary places, creating new triangles and vertices in the process. That part of the divided polygon that is covered by the clothing is removed. That part of the divided polygon that is still potentially viewable is geometrically reconnected to the body model.

After slicing, the divided polygon has created new geometry in the form of new vertices. As such, these vertices require texture mapping coordinates and skin weights. Texture mapping coordinates and skin weights are calculated and applied to any new vertices by interpolating data between adjoining vertices. After slicing, body geometry that is hidden by the clothing can be completely removed. It is important to note that the slicer objects are constructed by an artist for each piece of clothing and are therefore unique for each clothing model.

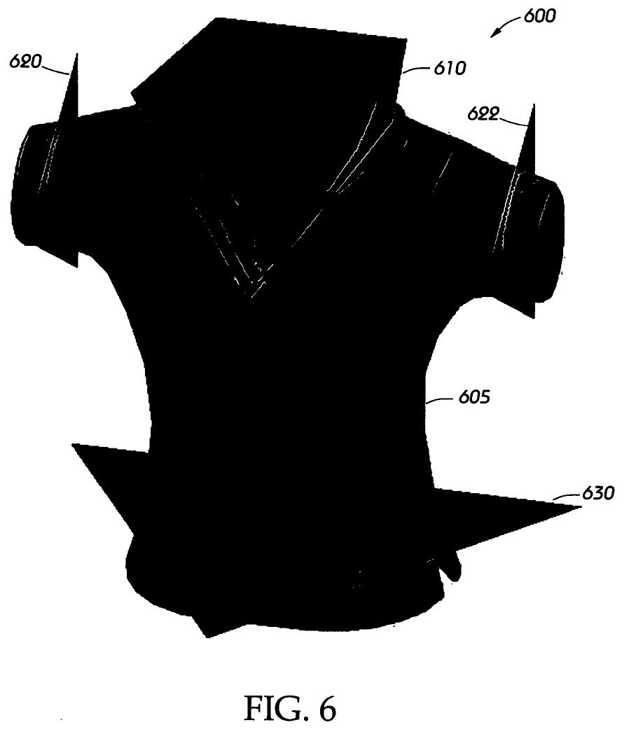

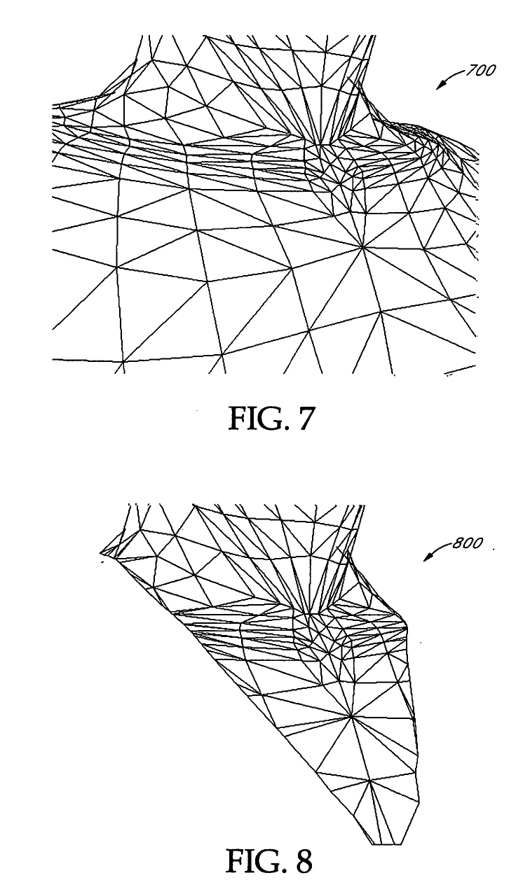

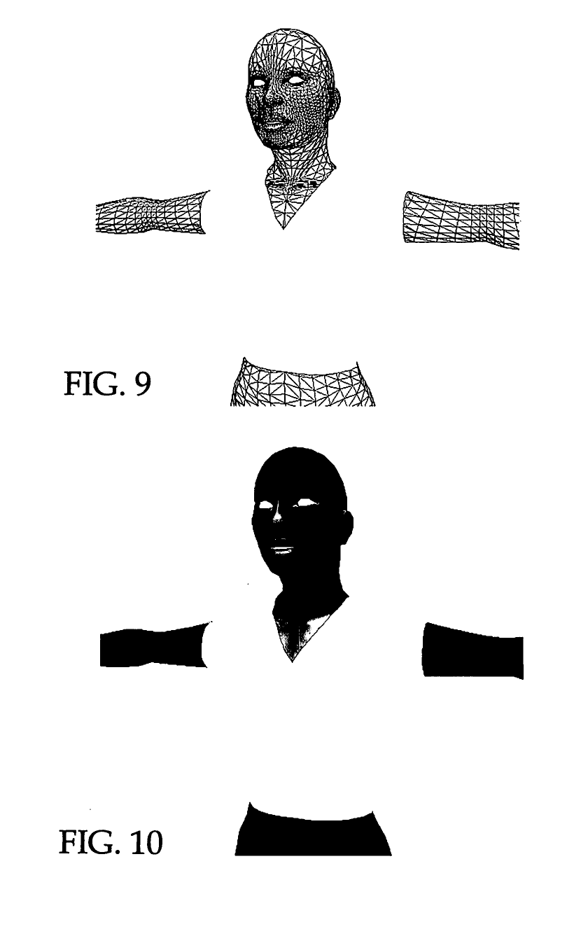

During the event-driven preparation stage, these slicers will cut the nude model, and all nude model geometry that is within the slicing region is discarded. FIGS. 7 and 8 are example graphical illustrations of a nude avatar model bisected by a slicer in the collar region of a shirt. FIG. 7 illustrates a portion of nude avatar model before slicing 700, while FIG. 8 illustrates the nude model after being sliced 800. FIG. 9 shows an example of the nude model sliced by all of the shirt slicers. All triangles have been removed in the region covered by the shirt, i.e., the region bounded by the slicers.

The nude model is sliced by all clothing models that the avatar wears. FIG. 28 depicts one embodiment of Body Model Slicing process 544 of the Model Preparation process 310 (FIG. 5). Starting with loop 2802, the process slices the body from the feet upwards. This ensures maximum removal of polygons. For example, consider an avatar wearing boots and long pants. Suppose further that the boots contain a single slicing object near the top of each boot. Also suppose that the pants contain slicer objects near the cuffs and these are below the boot slicer objects. If the process were to process the pants first, all leg polygons would be removed. If all leg polygons were to be removed, then when the boot slicers are processed they no longer have any body geometry to intersect. This would leave the entire foot geometry below the cuff slicers in place. However, if the boots are processed first, the boot slicers remove all foot geometry. Now when the pants slice, the cuff slicers do not have any geometry to slice. However, the waist slicer will slice the avatar at the waist and all polygons below the waist will be removed. Therefore, all of the avatar's geometry below the waist is removed.

For each region A, the process sorts clothing from outermost to innermost at state 2804. This improves efficiency as outer layers of clothing are generally larger than innermost layers. Therefore the potential to remove more polygons is greater if outermost layers are processed first.

The process distinguishes which polygons are to remain by consideration of the normal vectors associated with the slicing objects themselves. During model construction, the slicing objects are oriented so that their normals point towards the direction of those triangles which are to be preserved. By way of example, consider a slicer for a shirt sleeve. The simplest form of slicer in this case would be a single large triangle that bisects the arm near the end of the sleeve. This triangle's normal will face out towards to the hand, indicating that the polygons to that side of the triangle are to remain while the body's geometry on the other side of the slicer will be removed. In certain embodiments, a given piece of clothing will contain two or more slicers. They necessarily form a bounded region of space wherein all body geometry may be removed. The process performs the removal by initially constructing linked lists of connected polygons when the body model is read up from disk. Therefore the process knows, for every triangle in the model geometry, what its adjoining triangles are. Given that information, the process can choose one triangle (a “seed” triangle) on the removal side of a slicer and then proceed to recursively walk through all connected polygons and remove them as it goes. Since the slicers define a bounded region, removal remains confined to the bounded area of the slicers. Thus the correct body parts are removed from the model. In loop 2808 of FIG. 28 each slicer is iterated over. At state 2820 the slicer cuts the body model. It is worth noting that the process will choose a seed triangle for each slicer object from a clothing model. In the case where the nude model is sliced by multiple clothing articles, disjoint regions of geometry can be created. By performing the recursive walk over every seed triangle in state 2834, the system maximizes the number of polygons removed. In the example shown in FIGS. 8 and 9, the region being removed is completely connected so all polygons will be removed during processing of the first seed triangle.

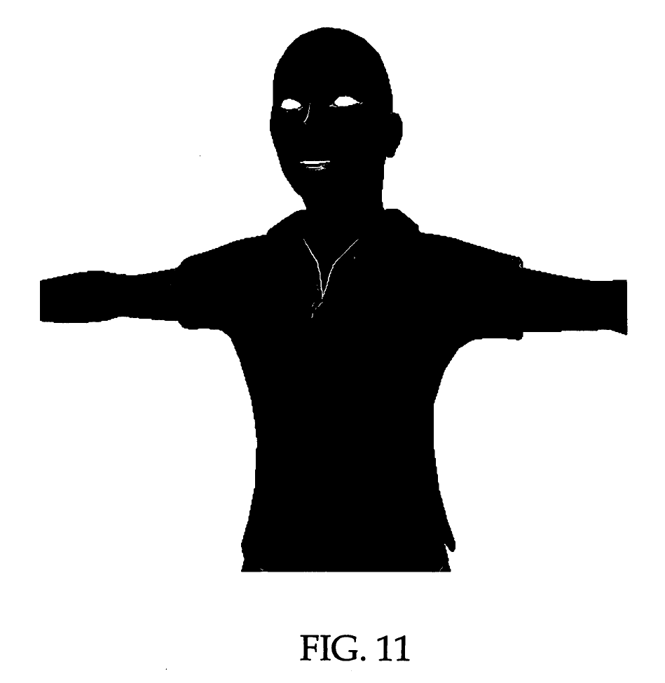

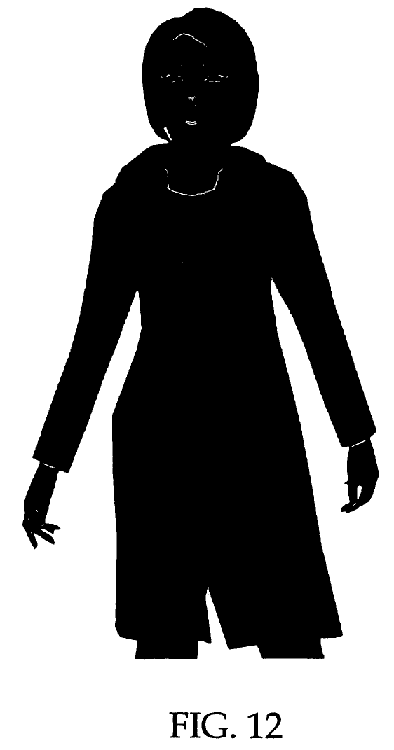

The data for texturing and animating the nude model is then interpolated to include the new vertices and triangles. FIGS. 10-11 illustrate examples of the shirt model and avatar model being rendered together. FIG. 10 illustrates the avatar model with the removed region, but with the texture applied. FIG. 11 illustrates the textured avatar model being rendered together with the shirt model.

The above discussion only considered a single layer of clothing on the body. The graphics process allows for multiple clothing layers, and as such, the body may be sliced by more than one article of clothing in a given region (torso or legs). Additionally, underlying clothing layers themselves are sliced by outer clothing layers. This process is detailed later.

3. Clothing Process

This section presents a detailed discussion of individual process of the Model Preparation process 310 (FIG. 5) invoked when a user changes the avatar's clothing.

### i. Exclusion Testing

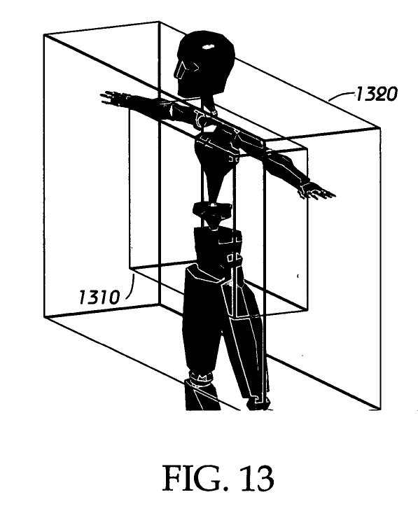

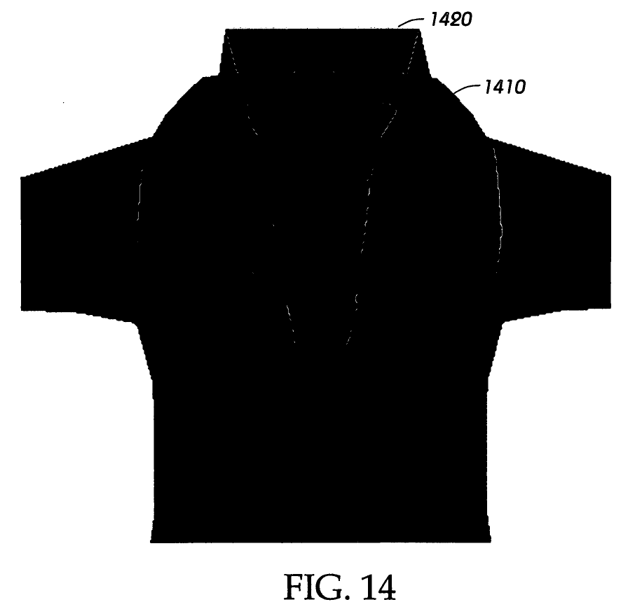

To assist in overcoming the bleed-through problem as discussed in section 3 of the Introduction, a test is performed to determine if any clothing item can be completely removed. After the raw data is loaded in state 502 of process 310, the system advances to a clothes occlusion/exclusion process 510 where the system determines if a whole model can be excluded from the rendering process. It would be excluded if it is entirely occluded by some outer layer of clothing. Visual occlusion is calculated for each item that is potentially hidden by an outer layer of clothing. The graphics process determines if an item is occluded as this allows the process to remove it from the clothing list, thus increasing efficiency. One embodiment of the Clothing Occlusion/Exclusion process 510 is shown in FIG. 26 and begins at loop 2602. This loop performs the occlusion calculations based on body region. The iteration is over feet, legs, and then torso. For each of these regions, occlusion begins with state 2604 where clothing layers are sorted from inner to outer. The process proceeds to loop 2606 where each item in the list is iterated over (which is referred to as item B in the diagram). The item from loop 2606 is tested against all items that potentially cover it (which is referred to as item C in the diagram). These items are accessed in loop 2608. The actual occlusion test begins at decision state 2610, where the process performs a fast bounding box test of item B against item C. All vertices of an inner layer must be contained within the bounding box (defined by the x, y and z extents of the item's geometry) of one of the outer layers in order for it to be occluded. More specifically, the inner layer's bounding box must be contained within an outer layer's bounding box. Due to the nature of an article of clothing's edges (the collar regions, shirt tails, etc), it is still possible that even if the item's bounding box is entirely encapsulated by another item's bounding box, the item can be seen, as shown in the example FIGS. 12 and 13. FIG. 12 shows the avatar wearing a shirt and a coal. FIG. 13 shows the bounding boxes of the clothing, though not the clothes. In these figures, note that the extents of the shirt's geometry are contained within the extents of the coat's geometry. This is evident in the fact that the maximum and minimum values of all three coordinates of the shirt (x, y, and z), are contained within the maximum and minimum values of all three coordinates of the coat. However, even though a bounding box 1310 of the shirt is within a bounding box 1320 of the coat, the open collar of the coat permits viewing part of the shirt. Therefore, in this case, encapsulation is not sufficient to exclude the shirt. While this is a required condition to exclude a clothing item, it is not a sufficient condition.

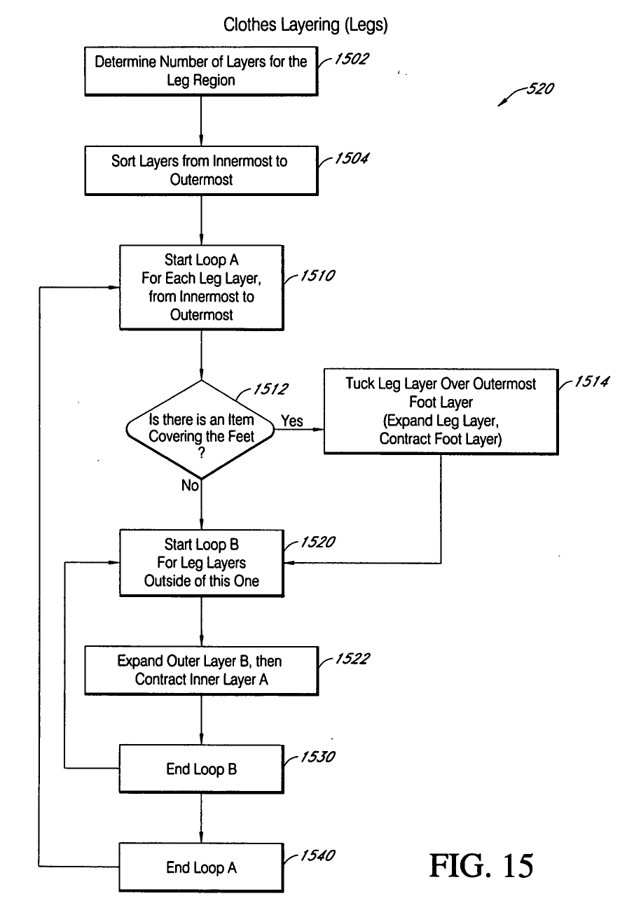

Returning to the discussion of FIG. 26, if the result of decision state 2610 is true, that is, item B's bounding box is contained within item C's bounding box, then the system moves to decision state 2612, where a test is performed to determine if the outer layer C can slice the inner layer B. In certain embodiments, due to the nature of slicer construction and their placement, they necessarily follow the edge boundaries of clothing items. They will either intersect or ring the perimeter of any holes that exist in the topology of an article of clothing. These holes include collars, shirt sleeves, pant legs, shoe tops, etc. If an inner article of clothing extends past one of these edges, some part of the article of clothing will be seen. The procedure at decision state 2612 is to attempt to slice the inner layer by the potential occluder, and determine if any inner layer polygons have been cut. If an inner article of clothing is contained within an outer article of clothing's bounding box, and if the slicers from the outer article do not cut the inner clothing article anywhere, it can be assumed that the inner article of clothing will be visually occluded by the outer layer, and can therefore be removed by the graphics process. Therefore, if the result of decision state 2612 is that the outer layer C's slicers do not intersect layer B, then the process advances to state 2614 where the layer B is determined to be occluded and omitted from the clothes list. Referring to an example shown in FIG. 14, a slicer 1420 around the coat's collar, 1410, intersects the shirt; therefore the shirt will be visible.

### ii. Clothes Layering

To assist in overcoming the bleed-through problem as discussed in section 3 of the Introduction, a set of clothes layering processes are invoked. The graphics process contains several facilities, processes 512, 520 and 530 shown in FIG. 5, whereby multiple layers of clothing can be placed on the avatar. In certain embodiments, the avatar is conceptually divided into four regions. Specifically these regions are the head, torso, legs, and feet. A given article of clothing is defined to cover one or more of these regions. Hair will cover the head, a shirt will cover the torso, pants will cover the legs and shoes will cover the feet. Other embodiments may not wish to divide an avatar or 3D object into these regions, or may determine that alternative zones or regions or less regions are appropriate. However, the same methods are still applicable.

Along with the 3D data that defines the clothing, in certain embodiments, the clothing also carries data that identifies what part or parts of the body it covers. For example, a long coat will cover both the torso and the legs. Specifically, layered clothing refers to two or more articles of clothing that cover the same region of the body. In certain embodiments, all exported 3D clothing models also carry data that identifies the clothing's layer. In certain embodiments, layers are segregated and identified by assigning a layer number to each item of clothing. For each body region, the graphics process can in principle support any number of layers. However, a particular embodiment may wish to limit the number of layers for practical purposes, including speed and efficiency of processing the clothing change. One embodiment limits the number of layers to three. By way of example, a bathing suit top would be assigned to the lowest layer, a blouse to the next layer, and a coat to the highest layer. The assignment of a layer number is subjective. The system works by only allowing only one piece of clothing per layer for a given region to be worn by the avatar. Therefore the user cannot wear pants and shorts at the same time as they will both cover the legs and would both be assigned the same layer number.

Note that in certain embodiments, layering may be partially automatic or partially user-initiated. While the user can designate items to be worn, the system will prevent certain combinations in accordance with the above mentioned layering scheme. Other embodiments may not place such restrictions on clothes layering, or may define other rules for restrictions, as the graphics process herein does not inherently engender any restrictions. A particular embodiment may or may not define rules or make decisions about the final state of the clothed avatar. As an example, a particular embodiment may introduce “dressing room” concepts wherein a participant could place any number or types of clothing on the avatar in any order.

In one embodiment, the process of layering clothes incorporates three distinct processes, the first two of which are depicted in FIGS. 15 and 16. FIG. 15 demonstrates the first and second processes as applied to the legs while FIG. 16 demonstrates these two processes as applied to the torso. The first process involves making sure that outer layer geometry is sufficiently pushed out away from the body to completely cover the inner layer geometry. The second process considers the overlap of a shirt over pants or a skirt, or the pants over footwear (for example, boots), referred to as “tucking out”. A third process involves outer layers slicing away geometry from inner layers where they overlap, and is discussed in the next section.

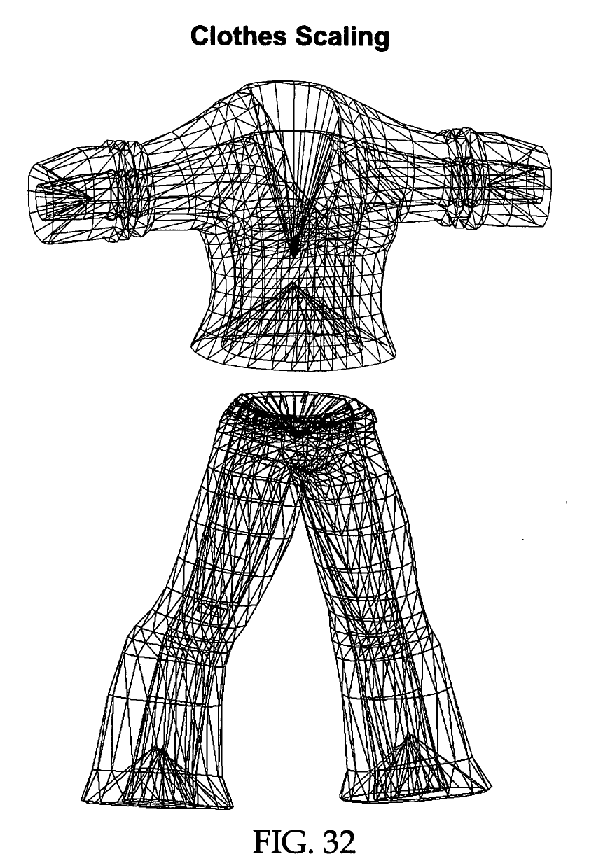

The need for the first process is as follows. It is desired to minimize any constraints on the design of an individual article of clothing so the artists have freedom to create realistic models. Given this freedom, it is not guaranteed that, for example, a sweater's geometry will everywhere fall outside of a loose fitting shirt's geometry. By way of example, consider FIG. 31. In view A the avatar is displayed wearing a very loose shirt. In view B, a tight sweater has been added. The sweater is (incorrectly) shown as mostly underneath the shirt and intersects it in various places. In view C, the system has performed intersection correction to ensure that the outer layer, the sweater, is entirely outside the inner layer and there are no intersections.

The second process is termed “tucking out”. In this process, geometry covering the torso is compared to geometry covering the legs and is pushed out in areas where the torso geometry should overlap the legs geometry. The result is that shirts tuck over pants and pants tuck over footwear.

Referring to FIG. 15, clothes layering (legs) process 520 begins by determining the number of layers that cover the legs at state 1502. State 1504 then sorts these layers from outermost to innermost. The process then enters loop 1510 for each leg layer, from innermost to outermost.

At a decision state 1512 in FIG. 15, the process 520 determines if it must tuck a leg item over a foot item. If the result of decision state 1512 is true, the process advances to process 1514. Here the leg layer is expanded over the foot layer and the foot layer is contracted under the leg layer in accordance with the description above to resolve any intersections. If the result of decision state 1512 is false, the process enters loop 1520. Loop 1520 iterates over all leg layers that are outside of the current layer in loop 1510. For each layer in loop 1520, process 1522 expands the outer layer and contracts the inner layer to resolve all layer intersections.

Once all layers outside of the current layer in loop 1510 have been processed, loop 1520 ends at state 1530. When all leg layers have been processed in loop 1510, process 520 ends at state 1540.

Both processes 1514 and 1522 employ a unique expansion/contraction method for resolving vertex intersections. Considering clothing geometry as a set of connected vertices, there are two sources of intersection. One is where a vertex from an “outer” layer of clothing lies beneath the inner layer, and the second is where the vertex from an “inner” layer of clothing lies outside the outer layer. Therefore the method involves the removal of intersections caused by both situations. The outer layer is the layer that is expected to be on the outside of the inner layer, whether or not this is consistent with the details of the geometry. The algorithm ensures the outer layer is properly outside the inner layer. To test if any vertices from the outer layer fall inside an inner layer, a special intersection test is performed. Specifically, a copy of the outer layer is created. This outer layer is then scaled with respect to the body model to create a larger version of the clothing model. For each vertex in the clothing model, a line segment is defined that passes from the scaled model to the original model. If this line segment intersects any inner layer polygon, then that polygon must lie between the original outer layer and the scaled outer layer. The point of intersection is found and the outer layer's vertex is moved outwards, along the line segment, such that it is outside the inner layer's geometry. The inverse process is also performed, wherein the inner layer geometry is moved inwards where necessary. This process also has the effect of making outer layers conform to the inner layers they are covering. In the subsequent discussion, clothing layers are adjusted through a series of acts, each leaving a given clothing layer in a new state. The term “original”, at a given act in the process, will therefore refer to either the true original clothing layer if no act has yet been applied, or to the modified version of the layer following all completed acts up to that point.

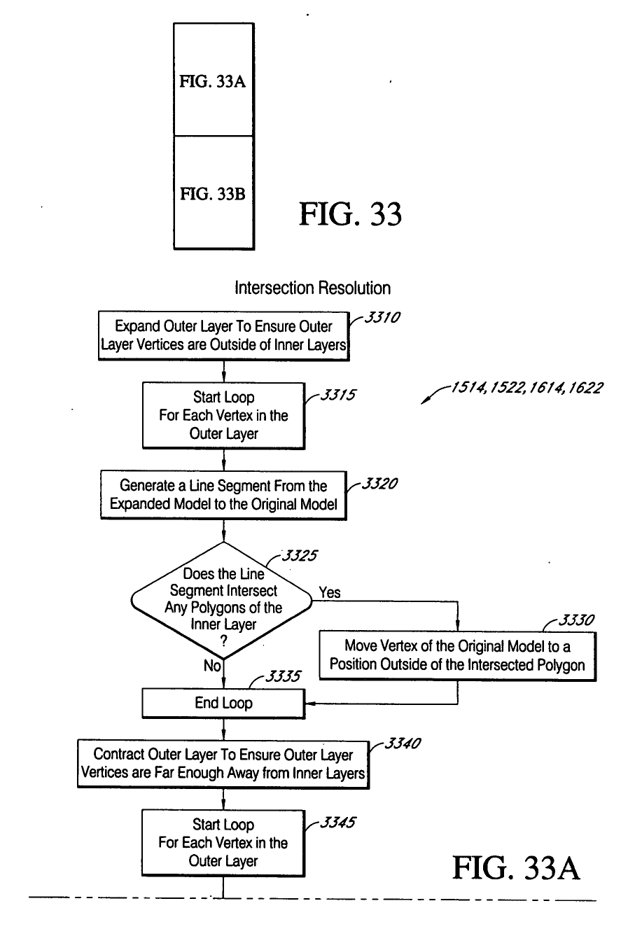

In certain embodiments, the scaling of clothing items is accomplished by defining points, lines and localized regions of the avatar and performing scaling operations with respect to those geometric entities. In this way, variations in X, Y, and Z scaling are localized and region-dependant, producing an optimized scaling. For example, at the ends of the sleeves, it is desired to have no scaling in the X-direction (along the length of the sleeve), but only circumferentially (Y, and Z). The scaling is designed to be continuously smooth over the geometry of the clothing item. FIG. 32 displays examples of expanded wireframe meshes for an item that covers the torso and one that covers the legs.

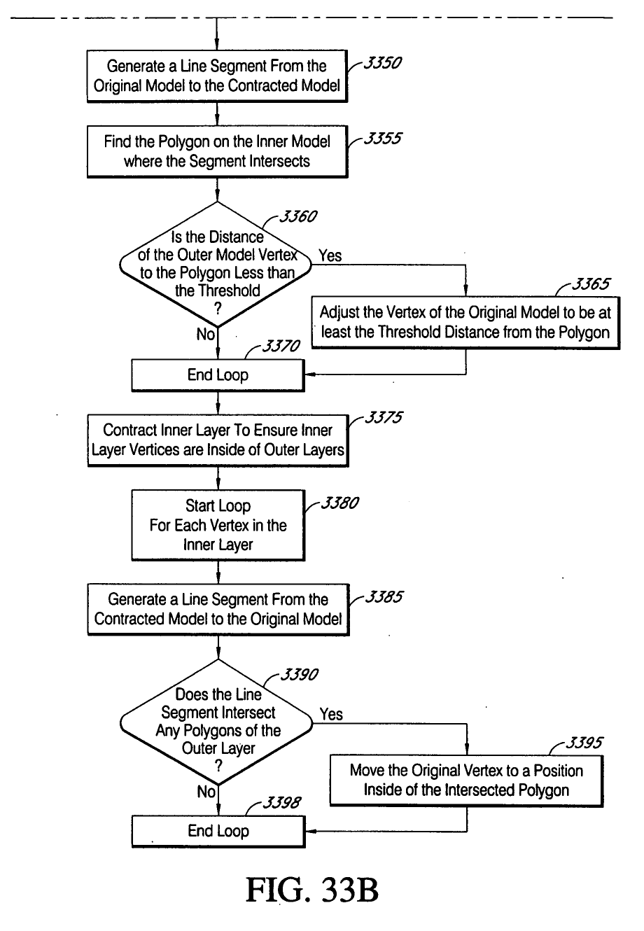

One embodiment of process 1522 (and similarly for processes 1514, 1614 and 1622) is displayed in FIGS. 33A and 33B. At state 3310 of FIG. 33A, the outer original layer is expanded, as demonstrated graphically in FIG. 32, to ensure that outer layer vertices are outside of inner layers. Expansion of this layer involves scaling the model to an extent that it becomes larger than the any potential inner layer which may reside under it. The best values for outer layer expansion can be determined by trial and error, and may be implementation-dependant. In certain embodiments, scaling factors on the order of 1.7 work well. Loop 3315 then iterates over all vertices in the outer layer. For each vertex, a line segment is generated between the expanded outer layer and the corresponding vertex of the original outer layer at state 3320. Decision state 3325 queries whether this line segment intersects any polygon from the inner layer. If it does, then the vertex of the original outer layer lies underneath the inner layer. If the result of state 3325 is true, then the process proceeds to state 3330 where the vertex of the original outer layer is moved along the line segment to a position outside the intersecting polygon. The loop returns to loop 2315 to process any additional vertices at state 3335 until all the vertices are processed. At this stage, all outer layer vertices are outside of the inner layer.

The next portion of process 1522 next ensures that all of the outer layer vertices are a minimum distance from the inner layer. This aids in correcting bleedthrough problems that can occur during animations when an outer layer vertex is very close to an inner layer polygon. Proceeding to state 3340, the expanded outer layer is contracted to ensure that outer layer vertices are far enough away from inner layers. The best values for outer layer contraction can be determined by trial and error. In certain embodiments, scaling factors on the order of 0.7 work well. Loop 3345 iterates over all vertices in the outer layer. For each vertex, at state 3350 a line segment is constructed from the original outer layer to the contracted layer. At decision state 3355, the process determines which polygon of the inner layer is intersected by the line segment. At state 3360, the process determines the distance of the vertex from the intersected polygon. If the distance is less than a prescribed threshold, the process advances to state 3365 where the vertex of the original outer layer is moved along the line segment to a distance from the polygon equal to the threshold value. The contract outer layer loop terminates at state 3370 when all the vertices in the outer layer are processed. The intersection resolution process 1522 continues in FIG. 33B.

At state 3375, the inner layer is contracted to ensure that inner layer vertices are inside of outer layers. The best values for inner layer contraction can be determined by trial and error. In certain embodiments, scaling factors on the order of 0.5 work well. Loop 3380 iterates over all vertices in the inner layer. At state 3385, for each vertex, a line segment is constructed from the original inner layer to the corresponding vertex of the contracted inner layer. Decision state 3390 queries whether the line segment has intersected any polygons from the modified position of the outer layer. If so, the process advances to state 3395 where the vertex of the original inner layer is moved along the line segment to a position beneath the outer layer. The loop terminates at state 3390 when all the vertices in the inner layer are processed. In other embodiments, other orderings of expanding the outer layer and the associated test loop (e.g., states 3315-3335), contracting the outer layer and the associated test loop (e.g., states 3345-3370), and contracting the inner layer and the associated test loop (e.g., states 3380-3398) can be done with minor modifications.

A clothes layering (torso) process 530 occurs for the torso in FIG. 16 that is analogous to the clothes layering (leg) process 520 shown in FIG. 15. States 1602, 1604 and 1610 are analogous to states 1502, 1504 and 1510 of FIG. 15. At a decision state 1612 process 530 determines if it must tuck a torso item over a leg item. If the result of decision state 1612 is true, the process advances to process 1614. Here the torso layer is expanded over the leg layer and the leg layer is contracted under the torso layer in accordance with the description above (for FIGS. 33A and 33B) to resolve any intersections. If the result of decision state 1612 is false, the process enters loop 1620. Loop 1620 iterates over all torso layers that are outside of the current layer in loop 1610. For each layer in loop 1620, process 1622 expands the outer layer and contracts the inner layer to resolve all layer intersections. Processes 1614 and 1622 have already been described above in conjunction with FIGS. 33A and 33B. Once all layers outside of the current layer in loop 1610 have been processed, loop 1620 ends at state 1630. When all torso layers have been processed in loop 1610, process 530 ends at state 1640.

A final clothes slicing process, 540 shown in FIG. 5, involves slicing away inner layer geometry that is covered by outer layers. This process is performed along with other clothes slicing routines, and is discussed below.

### iii. Clothes Slicing

Following the occlusion tests and layering process, outer layers of clothing must slice away inner layers of clothing where they overlap. The process 540 is described in conjunction with FIG. 17. Process 540 is performed for each region (feet, legs, and torso) separately in loop 1702. In state 1704 clothes for a given region are sorted from innermost to outermost. Process 540 then iterates over each item. At a decision state 1712, it is determined if the outermost layer is being processed. If not, then the process 540 advances to state 1714 where all layers outside of this one slice it. If the clothing layer is an inner layer, then all layers outside take part in slicing it. If not, then the process proceeds to a decision state 1716. Decision state 1716 determines if the process is tucking, in which case cross-region slicing is implemented. If the item is a boot, for example, and pants are tucking over it, then those pants slice away the parts of the boots that they cover. The same processing occurs for pants wherein a shirt may tuck over it and subsequently slice away some of its geometry. If the process is tucking, meaning this is a leg item and a shirt tucks over it, or if it is a foot item and a legs item tucks over it, then the process 540 advances to state 1718. At state 1718 the item that is tucked out slices the item it is tucking over. After state 1718, or if decision state 1716 is not true, then loop 1720 ends. Loop 1702-1730 is then performed for the next region until all regions are processed.

### iv. Body Slicing

Subsequent to clothing occlusion tests, clothes layers, and clothes slicing, the Model Preparation process 310 shown in FIG. 5 advances to the Body Model Slicing process 544 shown in FIG. 28, previously described. Here, the process will slice away portions of the nude model that are covered by the clothing. Specifically, this process starts at the feet and works its way upward. In this fashion, maximum removal of polygons can be achieved, By way of example, consider a boot, with its slicer at the top of the boot. Then consider pants that are worn over the boot with its leg slicers positioned at the cuff of the pants and a slicer at the waist as well. If the pants were to slice the model first, then the entire trunk and leg region would be removed, leaving the feet below the cuff. Next, when the boot slicers attempt to slice the model's legs, the region of the leg where the boot slicer would intersect would already have been removed, and the boots would not remove any geometry. In this case, the nude model's feet below the cuff are not removed.

Instead, if the boot sliced the nude model first, it would remove the feet and calves. Now when the pants slice the body, even though the cuff slicers do not intersect anything (that region has been removed by the boots), the waist slicer still intersects triangles at the nude model's waist. This results in the entire remaining lower portion of the model being removed. So therefore, more effective removal of geometry has been achieved since in this case all polygons below the waist have been removed.

Specifically then, in certain embodiments, nude model slicing proceeds by slicing the foot region, followed by the leg region, followed by the torso region. For each region, the order of slicing is outer layers first, then inner layers, as it is usually the case that outer layers cover more geometry and hence tend to slice away larger regions. This optimizes the speed of the process.

4. Deformer System

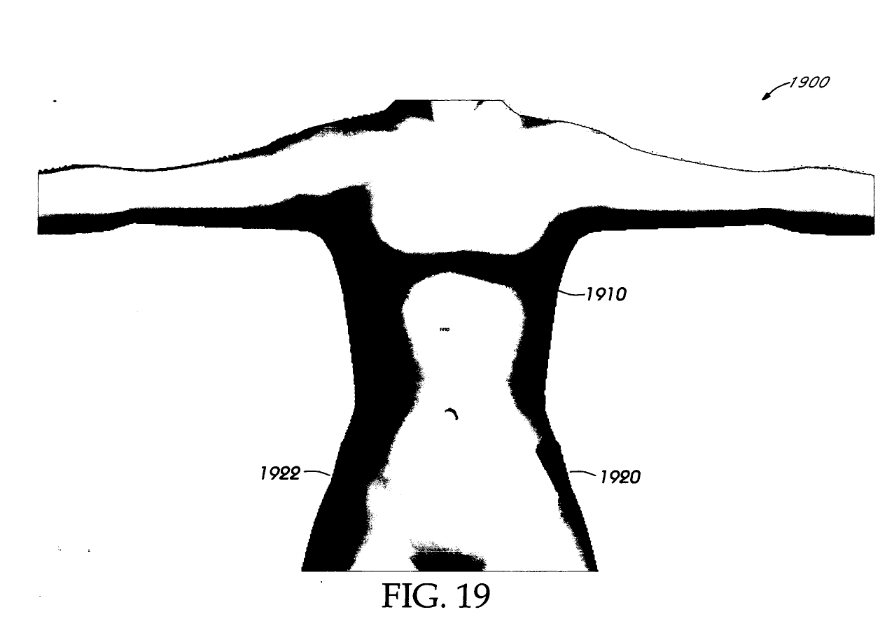

After all slicing is completed the Model Preparation process 310 (FIG. 5) advances to process 550 which is the model deformer system, one embodiment of which is illustrated in FIG. 18. The deformer system is used for both event-driven and recurring data processing and is applied after all model slicing has occurred. During event-driven processing, the deformer system responds to user interaction and sets up data buffers. During recurring processing, these data buffers are applied to the avatar. The deformer system provides continuous deformation control of the avatar's features. There is fundamentally no limit to the number of deformers that may be applied to an avatar, however, practical considerations dictate applying subjective limitations on the types and extents of the deformations.

The process makes use of “morph targets”. Morph targets are a standard 3D graphics technique used to change the appearance of some object such as a facial feature. A morph target is a copy of the original model with some or all of its vertices shifted in position. This represents a model that looks physically different to the user. For example, a 3D artist may construct a copy of the avatar's face that exhibits a wider nose. Provided the morph target contains the same number of vertices as the original, and provided there is a one-to-one mapping of the vertices, the original model can be gradually transformed into the morph target by way of interpolating the vertex positions. A more general term, “morph”, is also used to convey a change in the physical representation of a 3D model, whether that change was derived from a morph target, or by other means. The present system uses morph targets for facial deformations, and unique algorithmic methods for creating body morphs.

In certain embodiments, all facial morphs, body morphs, and facial animations (including eyeblinks) are performed in the deformer. Additionally, the deformer system contains two more deformers that act on the hair. One of these systems pushes hair away from clothing. The other moves hair to enforce conformance with the face if a user modifies the overall shape of the face. Facial, body and hair morphs are event-driven processes, while facial animations are recurring. While the current embodiment places all morph and facial animations in a single deformer module, this is not inherently dictated by the graphics process. Other embodiments may place morph and animations in separate modules as deemed fit.

In certain embodiments, a buffering system is used by the deformer system for efficiency. Each model that makes up the avatar, which include but are not limited to, the nude model, clothes, hair and other accessories, contains a deformer system. In certain embodiments, each deformer system is supported by four separate buffers. These are a morph buffer, facial animation buffer, eyeblink buffer, and an overall model state buffer that holds the complete deformed state of the model. Morph targets and animations both work by moving vertices on the model to new locations. Each of the aforementioned buffers, with the exception of the model state buffer, contains the differences between the initial model state and the final model state for their corresponding action. The model state buffer contains the complete final positions of the model's vertices, calculated by the total accumulation of all deformers. The difference buffers are calculated in response to event-driven user interaction; therefore the model state buffer is also calculated infrequently. As an example, if the user changes the model by accessing one of the facial modification sliders, the morph buffer would be calculated, followed by updating of the model state buffer.

Deformer update is performed each frame, however, event-driven processing of the buffers only occurs in response to user changes in the avatar. Referring to FIG. 18, an embodiment of Deformer System process 550 will now be described. In FIG. 18, loop 1802 is performed for each model that makes up the avatar. First the system queries if a trigger has occurred which will initiate such a change at a decision state 1804. If a trigger has occurred which involves a morph change, the process advances to process 1806, where the eyeblink sub-system adjusts its eyeblink animations (see section v below). In the next process, Bones Deformer process 1808, the system calculates the morph buffer (see sections i and ii below). Next the process checks to see if an eyeblink animation is running at a decision state 1812. If so, the process advances to state 1814 where the eyeblink buffer is updated. Moving to a decision state 1816, the process checks to see if a facial animation is running (see section iv below). If so, the process advances to state 1818 where the animation buffer is updated. Advancing to a decision state 1822, process 550 tests if it modified any of the buffers in process 1808, or states 1814 or 1818. If so, the full model state buffer is updated. Specifically, this is done by adding all the difference buffers to the undeformed model positions to create the final deformed model. In state 1824, the full model state buffer is applied to the model. Note that if all decision states 1804, 1812, 1816, and 1822 are false, the process simply copies the cached model state buffer to the model at state 1826. The loop starting at state 1802 ends at state 1828 for the current model. If there are additional models for processing, process 550 starts the loop for the next model at loop 1802. The following sections describe the sub-systems of the Deformer system.

### i. Facial Morphs

Facial morphs are accomplished by means of morph targets. A morph target exists for each facial deformation that the user can apply. The user enacts a deformation by interacting with a User Interface element. By way of example, it can be assumed that the User Interface element is a slider. Each morph target is then applied according to the value of its corresponding slider. By way of explanation, a feature such as a nose is drawn in an initial position and each vertex in the model has a spatial description for this position. A morph target is, for example, the nose in some altered position (perhaps wider). As such, each of the vertices has a new morphed position. When the user moves a slider, the deformer performs linear interpolation for each vertex between the original position and the altered position depending on the position of the slider. Facial morphs are calculated when the user moves a facial morph slider and thus the conglomerate morph state buffer is updated during event-driven data preparation. Although the system calls the deformer for each frame (recurring data preparation), the buffered morph state is not recomputed when there is no change in a slider value. It is important to note that even though facial morph calculations are streamlined to only affect vertices that actually move, the buffer applies to the entire model. In this way, the bones deformer below can write to the same buffer.

### ii. Body Morphs

### Bones Deformer

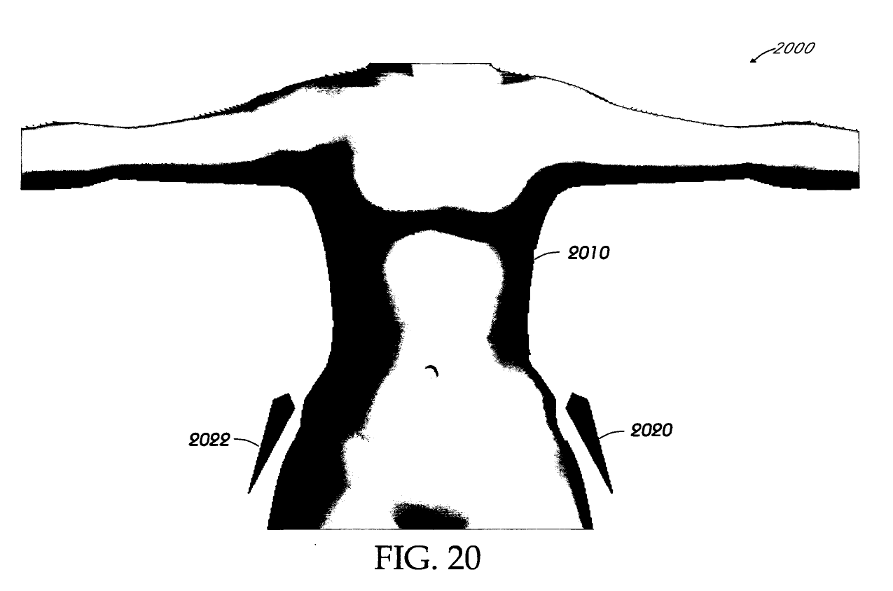

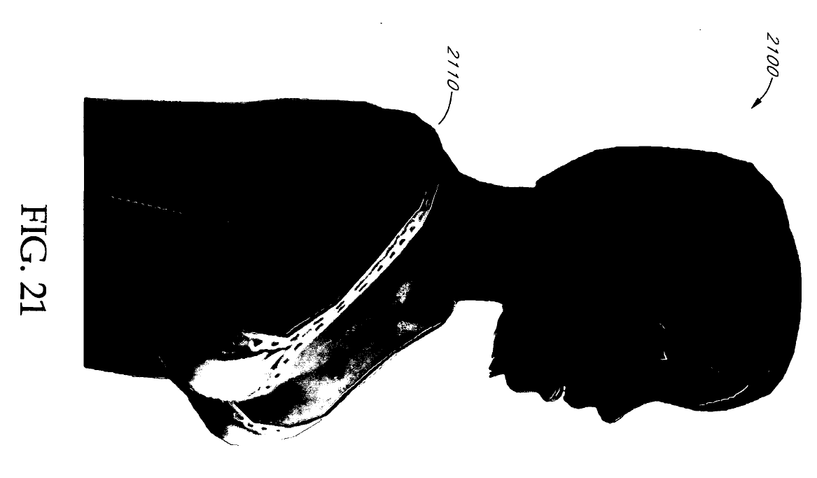

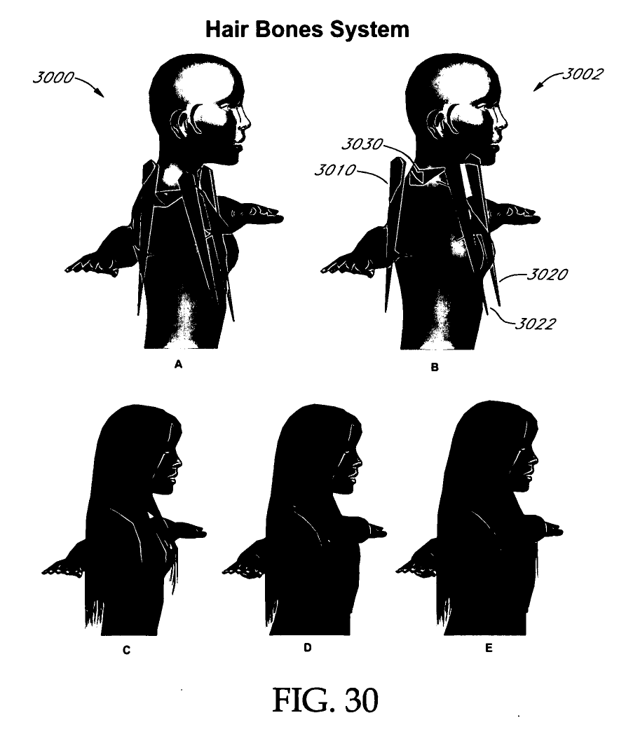

The shape of the avatar's body is controlled by a unique algorithmic deformer system that utilizes bone structures. Bone structures may be found in 3D character animation systems. However, the present system uses bones in a unique way to affect global deformation of the avatar's appearance. For a given body deformation, a corresponding set of bones is constructed by a 3D artist. Along with these bones, a spatial influence is defined that encompasses some subset of the avatar's vertices. Generally, this weighting is a function of distance from the bone. Spatial influences from one or more bones may influence a given vertex. A vertex is tied to the bone system via the weighting of these influences. When a deformation is enacted, for example when a participant moves a slider on a user interface, the bone is moved, rotated, or scaled in a prescribed fashion. As the vertices are tied to the bones system via the influences, they are moved along with the bones system. This results in a deformation of the model. As an example, consider FIGS. 19 and 20. These figures show examples of the orientations of the bones (1920, 1922, 2020 and 2022) system that deforms the avatar's hips (1910 and 2010) in the neutral orientation (FIG. 19) and deformed orientation (FIG. 20), respectively. When the user moves a slider, the bones are moved by a percentage of the total distance based on the slider position. FIG. 29 depicts one embodiment of the Bones Deformer process 1808 of Deformer System process 550.

The graphics process applies a given bones deformer to the nude model and all clothing models that the avatar is wearing. As the bones deformer is implemented as a spatial influence, the nude model and clothing models will be deformed in the same manner. Therefore, the rendered combination of deformed nude model and deformed clothing models appears as a single deformed avatar wearing clothes that conform to the avatar's body.

For each deformer, there is a maximum change in the orientation of the bones for that deformer, which defines a full deformation. By way of example, in the case of a slider, which may be positioned from 0% to 100%, the orientation of the bones is adjusted by a percentage corresponding to that of the slider. In this way, a participant may continually adjust the percentage of the deformation effect. In certain embodiments, movement of a slider user interface element results in a decision state 2902 of process 1808 returning true. When a user requests a change for a body morph at decision state 2902, the process proceeds to state 2904 and retrieves the percentage. At state 2906 the bones are oriented (position, rotation and scale) fractionally by the morph percentage. The bones deformation is applied to the vertices of the nude model and any clothing that the avatar is wearing. Note that the Bones Deformer process diagram, FIG. 29, does not show iteration over the nude model and all clothing, as the Bones Deformer process 1808 is already embedded in loop 1802 of the Deformer Process 550 (FIG. 18). Advancing to state 2908, the process updates the buffer for the bones deformation. As for facial morphs, when a body slider is not being moved (decision state 2902 returns false), the vertex data affected by its bone is not recomputed.

The vertex influences are not pre-calculated when the models are generated by the 3D artists. Rather, they are calculated when the models are loaded from disk. In this fashion, only the positions, rotations and scaling of the bones need to be present to define the deformation. Dynamic calculation of the influences provides maximum flexibility for the system. Since the influences are calculated dynamically, it is a simple matter to change deformation properties. If one desires to change how a particular deformer works, only the properties of the bone system need to be modified. There is no need to recreate, reconfigure or re-export the body or clothing models which, depending upon the embodiment, may be numerous. The same holds true if new deformers are added to the system. The system simply stores the new bone orientations. When a user moves a body deformation slider, the stored weights are used to move the body or clothes vertices. In this way, clothes and body vertices all deform by the same prescription. This gives the effect of the clothes taking on the form of the underlying body, even though large sections of the body may have been sliced away.

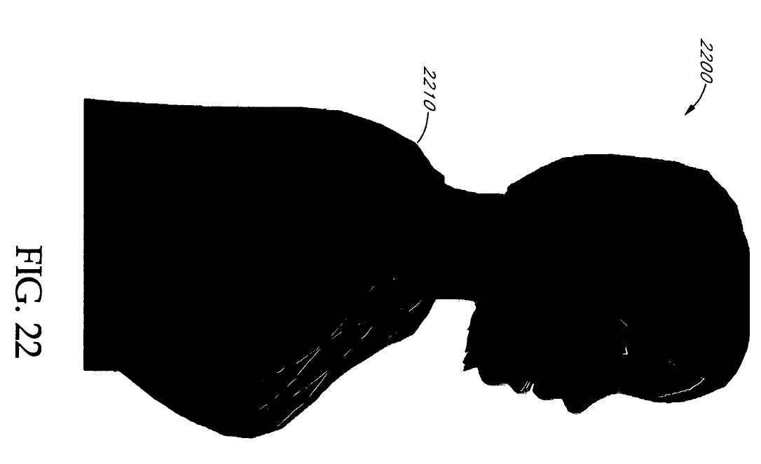

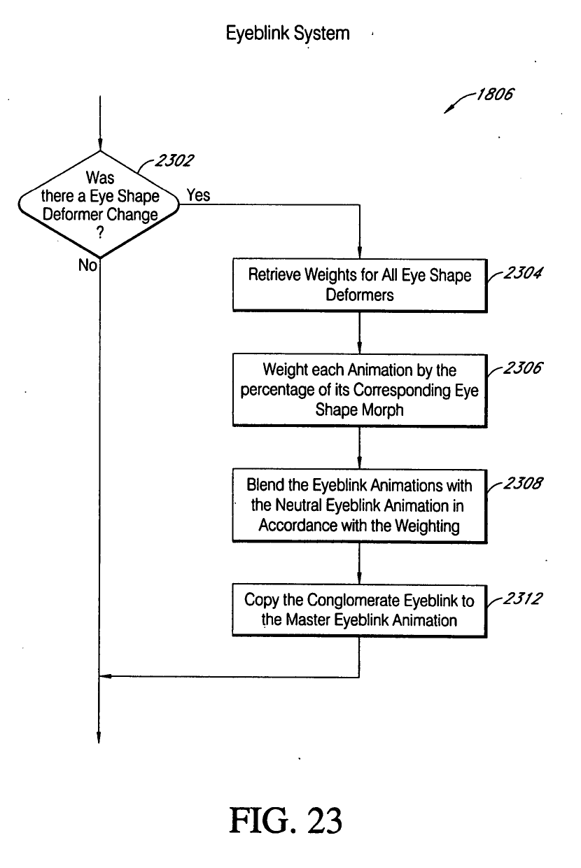

The body morph system also contains a unique chest/bust deformer, which is specific to female avatars. Two states of deformation are recognized, depending upon the type of clothing that the avatar is wearing. Certain clothing, such as, but no limited to, underwear and bathing suit tops requires the bust-line appear as would that of a nude body. This is referred to as “conforming” bust-line, since the clothes must conform to the nude body shape. Other clothing such as, but not limited to, shirts, sweaters and jackets, produce a bust-line that is defined by the clothing rather than the nude body, wherein the contours of the clothing are stretched and pulled by the breasts. This is referred to as a “non-conforming” bust-line. FIGS. 21 and 22 demonstrate the two situations. In FIG. 21 the example avatar 2100 is wearing a bikini top 2110 and the clothing conforms naturally to the bust. In FIG. 22 the example avatar 2200 is wearing a sweater 2210 and the abdominal area under the breasts is markedly different than in the conforming case. The same holds for the region in between the breasts. The system accomplishes this by defining two separate bones deformers for the bust-line. Additionally, data is attached to clothing items that cover the torso to indicate whether it is a conforming or non-conforming item. The graphics process determines the outmost clothing layer that covers the torso and selects which deformer to apply depending upon that layer's conforming designation. The two deformers must be carefully designed by a 3D artist such that the overall size and shape of the breasts appear equivalent for the two cases across the full span of deformer percentages.

### iii. Hair Deformers

As the avatar is customizable, there are two situations that occur where the avatar's hair must be deformed to conform to changes the user may make to the avatar. The first occurs if the user changes the overall shape of the face. The second occurs when an article of clothing must move the hair so that it does not intersect the clothing. For both of these processes, the mechanics of the deformer system are very similar to that discussed in section (ii), e.g., a bones system is used to move weighted vertices on a hair model.

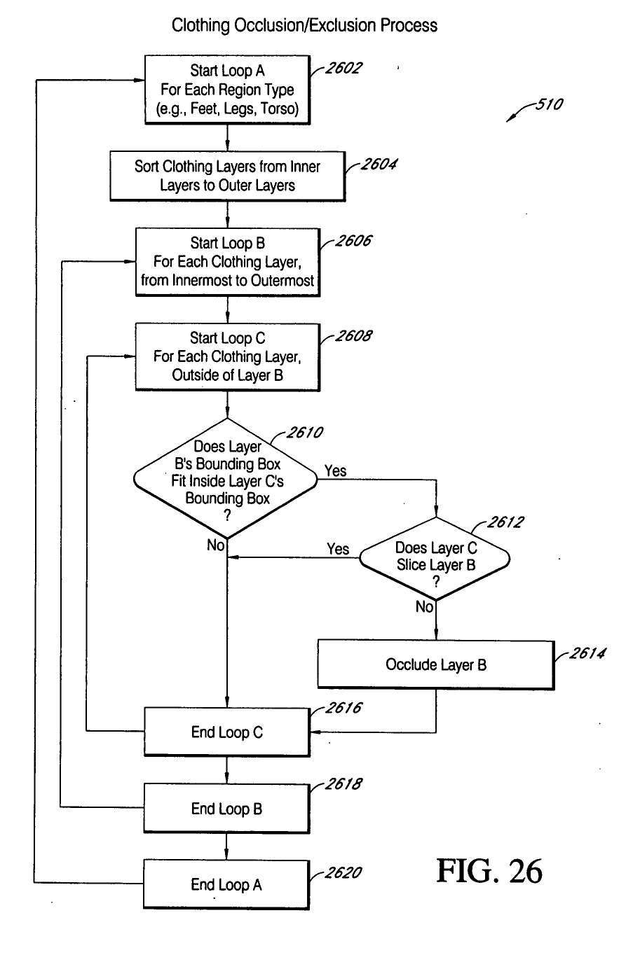

In one embodiment, the graphics system defines generic face shapes which include, but may not be limited to, round-, square-, oval-, and heart-shaped. In certain embodiments, hair models are distinctly separate from the body model. Therefore changes to the avatar's face that affect the face's overall structure are not automatically transferred to the hair model. Therefore, a hair deformer system is implemented to move the hair as necessary. This allows maximum flexibility to build large numbers of hair models and to add other face-structure deformers if desired. A set of auxiliary bones, similar in nature to the bones discussed in section (ii) are utilized to move hair in conformance with changes in the face. Each face type has an accompanying bones deformer for moving the hair. For example, if the user were to make a change to the face that resulted in the face being more rounded, the bones deformer for the round face shape would push the hair outward in an equivalent manner. FIG. 25 depicts an embodiment of the Face Shape Hair Deformer process 560. Decision state 2502 queries whether a change in a face shape deformer has occurred. If so, the process advances to state 2504, where the weight of that morph target is noted, the weight being the percentage of full deformation. In state 2506 the corresponding face shape hair bones are oriented fractionally by the morph percentage. In this way, the hair appears to deform along with the face.

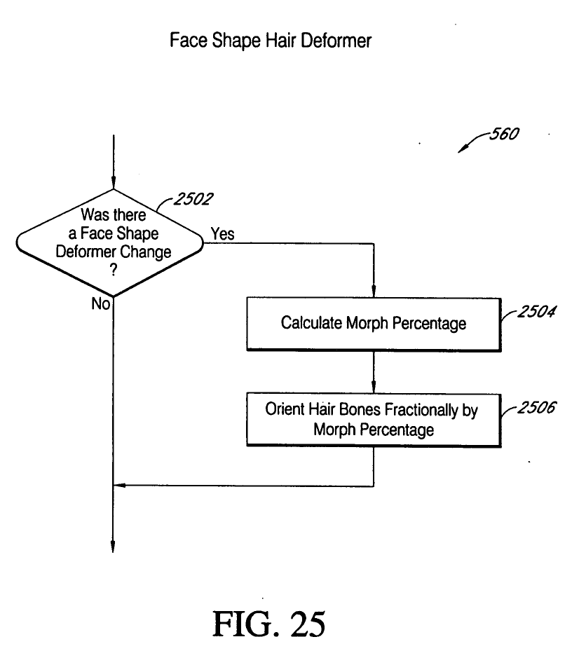

One embodiment of the second special deformer process for hair, process 570, is depicted in FIG. 24. This process is due to the situation that thick clothing may need to move the hair away from the body so that the hair does not intersect the clothing. Just as each face shape has a corresponding hair deformer, each article of clothing that covers the torso contains a bones system capable of moving the hair away from it. This bones system is exported with each piece of clothing and applied to the hair as the graphics process is constructing the avatar. Specifically, Torso Hair process 570 determines the outermost torso clothing layer at state 2402. This layer is used to move the hair. Decision state 2404 determines if the torso clothing item contains hair deformer data. If so, then the graphics process advances to state 2406 where a deformer added to the hair. This entails calculating the vertex weights for each bone as described in the Body Morphs section (ii). Finally, at state 2408 the hair deformer bones are oriented so as to push the hair into proper position with respect to the torso clothing item.

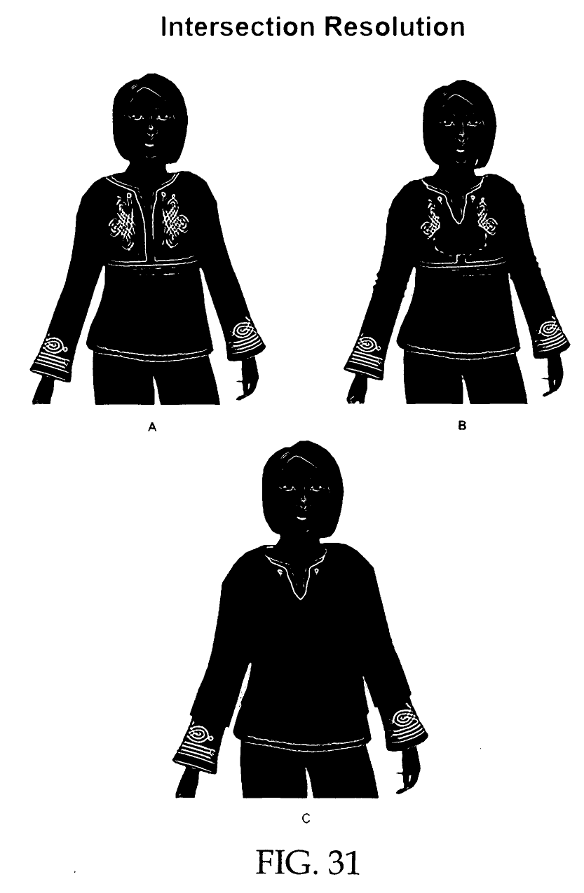

FIG. 30 demonstrates graphically a hair bones deformer system for the case where the hair must be moved to accommodate clothing such as thick clothing. In the embodiment shown in FIG. 30, four bones are used, although other embodiments may use any number of bones in any appropriate orientations. In view A, the bones system is displayed in its unperturbed orientation 3000. View B shows the bones in a modified orientation 3002 which will affect movement of the hair. By way of example, in view B the bone 3010 in back of the avatar has been pivoted back, the two bones 3020 and 3022 in front of the avatar have been pivoted forward, and the bone that runs along the shoulder 3030 has moved upwards. View C displays the avatar wearing the hair as designed by a 3D artist. The hair falls properly over the nude model's body. In view D the avatar has been dressed with a thick coat and the bones are in their initial orientations of view A. The hair and coat occupy the same space, so the hair intersects the coat. At view E, the hair bones have been re-oriented to the orientations of view B. Since the bones influence the hair, the hair is moved in such a manner as to eliminate any intersection.

### iv. Facial Animations

Facial animations are also applied via the deformer system. Facial animations are defined by a set of keyframed vertex positions for the face. For each frame, if a facial animation is occurring, vertex positions are calculated by interpolation over keyframes. Keyframed vertex animation is a standard 3D animation technique. The difference in vertex positions is stored in the facial animation buffer, and added to the final model state buffer.

The graphics process also contains methods for implementing special features during a facial animation. These include holding the end of a facial animation for a prescribed amount of time, playing sound clips during the animation, and specifying a body animation to accompany the facial animation.

Data accompanying the facial animation can specify a “hold time”. If the hold time is greater than zero, the final frame of the animation is continually presented to the user for that amount of time. Thus, the avatar can animate into an expression, and then hold that expression for a time period.

Likewise, data may accompany a facial animation that specifies playing a sound clip or executing a body animation along with the facial animation. By specifying a body animation, the facial animation can be more expressive, especially if the body animation contains head and neck movement, which is typically the case.

The deformer system is also configured to blend the final state of a facial animation with the initial state of a facial animation. Thus, if an animation is requested, the model transitions smoothly from its current state to the new animation. In the present implementation, after a facial animation has occurred, the blending system is used to blend the model back into a static facial position, typically a smile. Since this smile is static, the facial animation buffer does not need updating once in this position.

v. Eyeblink System

The Eyeblink system is a special case of the animation system. A single eyeblink animation is not compatible with morph targets that change the structure of the eyes. A single animation would define the eyeblink based on an undeformed model. However, since the user may be allowed to change the shape of the eyes by any number of controls, an eyeblink based on the undeformed model is invalid. Consider the undeformed eyeblink. The animation is defined by the upper eyelids moving downward until they touch the lower lid, and then moving back up. This data is stored as differences between the original vertex position and the animated vertex position. As long as the model remains undeformed, applying these differences each frame properly closes and opens the eyelids. By way of example, if the eye sockets are enlarged, then the stored difference for the eyeblink animation will not be sufficient to close the eyes completely. Likewise, if the eye sockets are shrunk, the lids will overrun their closed positions. This problem occurs for any eye deformer that affects a change in the eye sockets geometry. Note that deformers that result in strict translation of the eyes (up and down, or separating them) do not engender the problem, as the blink is additive. In that case, since the blink animation is applied as an additive difference, the eyes will blink properly. Rotations, scaling, and general eye socket shape changes will produce the problem during a blink. These are referred to as eye shape feature deformations. As such, the solution is to create an eyeblink animation from the neutral (undeformed) model and an eyeblink animation from each extreme of the eye shape morph targets. This correct eyeblink animation (called the master eyeblink animation) will be the result of blending these animations in accordance with the morph target percentages. This blending needs to be done only when a change in morph targets that affects the eyes is enacted.

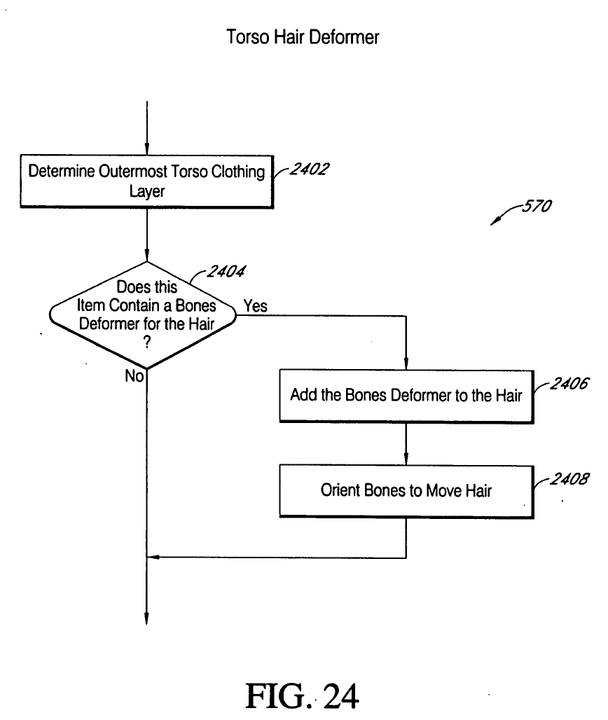

One embodiment of the eyeblink system process 1806 is shown in FIG. 23. Decision state 2302 looks to see if a change is made to the eye shape via one of the eye morph deformers. If the result of state 2302 is true, the process 1806 retrieves weights based on the percentage of deformation for all the currently set eye shape morph targets in state 2304. Advancing to state 2306, the process 1806 adjusts the corresponding relative weighting of the eyeblink animations to match the user's shape choices. In state 2308, blending the individual eyeblink animations in accordance with their corresponding morph percentages generates a combination eyeblink. The animation data generated as a result of the blending is equivalent to having read up a single animation file. The animation thus produced is copied to the master eyeblink animation in state 2312.

The deformer system also contains a provision for preventing either the right eye or left eye from blinking. When this provision is put in place, the avatar is seen to wink. Specifically, the deformer system can designate a time with respect to the start of a facial animation for such a wink process to take place. The wink time and wink property (left or right eye) may be embedded with any particular facial animation and subsequently stored in that facial animation's deformer.

5. Skin T one Process

Along with changing the avatar's features, clothing and hair, the avatar's skin color may also be changed by the user. The skin tone adjustment occurs in Model Preparation process 310 (FIG. 5) at process 580. Skin tone changes are performed by adjusting the colors of the individual pixels in the texture map that is applied to the avatar's body. The texture map consists of pixels of varying colors. The average color of the texture is that color which is most dominant. The skin tone system works by shifting this dominant color while preserving shadows and highlights.

The algorithm is best understood by considering color space. This is a space defined by three coordinates, one representing red, one green, and one blue. In certain embodiments, color is defined as standard 24 bit color, eight bits each for red, green and blue. The maximum value along each color axis is therefore 255, which is defined by 2^{N}−1, where N is the number of bits for one of red, green or blue. The color of each pixel in the texture map occupies a value in color space. Taken together, there is a distribution of colors in color space that creates a cloud of values. The algorithm samples each pixel and determines where in color space it resides. The distance between the pixel's color and the average color of the base texture map is calculated as the vector distance in color space. For example, if the color happens to be the average color, the distance is zero.

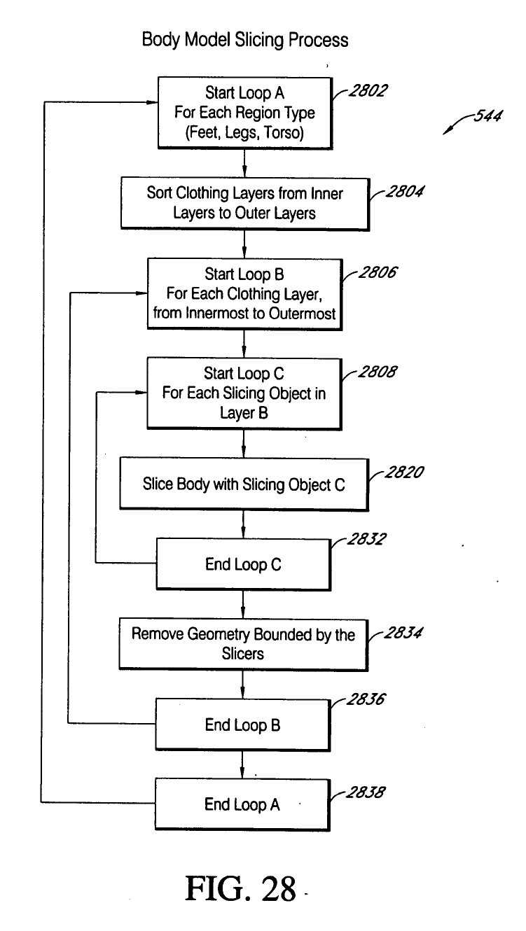

The requested skin tone color will become the dominant color of the new texture map. The algorithm first calculates the difference between the requested skin tone color and the base skin tone color. It then applies that difference to each pixel. However, the applied difference is weighted by the distance, in color space, between the original color in the pixel and the base skin tone average. Therefore, if the color in a given pixel happens to be the average base color, this color is completely shifted over to the new color. If the color is far from the base average, the shift in the red, green and blue components will be reduced by a multiplying factor. This has the effect of preserving colors that are far from the average, so that shadows and highlights are preserved. One embodiment of the Skin Tone process 580 is shown as pseudo code in FIG. 27. The process iterates over each pixel in the texture map. In certain embodiments, the equation for the color shift multiplier is given by:
distance1=(Rp−Ro)**2+(Gp−Go)**2+(Bp−Bo)**2
Multiplier1=(1.0−distance1/normalizer)
where normalizer is the distance of the pixel color to the point on the color cube that is farthest from the base skin tone color. The p subscript refers to the color of the current pixel, and the o subscript refers to the original component.

An additional weighting factor is also applied to further preserve highlights, so that values that tend towards white are even more restricted from changing. In certain embodiments, the equation for the second multiplier is given by:
distance2=(255−Ro)**2+(255−Go)**2+(255−Bo)**2
Multiplier2=(1.0−distance2/195075.0f)
where the value of 195075 is a normalization factor equal to the distance from pure black to pure white in color space, in one embodiment. As shown in FIG. 27, the color shift from base color to new color for the pixel is the difference between the new skin tone and the base skin tone multiplied by both Multiplier1 and Multiplier2.

Makeup is a texturing operation that is performed by overlaying a semi-transparent image over the avatar's original texture. Artists create the texture overlay in an imaging editing application and determine its position relative to the model's original texture map. When makeup is required in the game, a blending operation is performed in the region of the overlap. Specifically, this blending operation entails combining the pixels of the overlay with the pixels of the original texture map. In certain embodiments, for a given pixel, the makeup color is blended with the underlying color according to the following equation:
Cf=Cm*Alpha+Co*(1−Alpha).
Here, C refers to any of the red, green or blue components of the color. Cf is the final color, Co is the original color, and Cm is the makeup color. Alpha is the transparency value for the pixel, which can range between 0 and 1.0.

This technique is used for eye shadow, lipstick, and blush, and eyebrows. Blending of textures in this fashion is a method for modifying texture maps in 3D graphics applications. Application of makeup also occurs in state 560 of Model Preparation process 310 (FIG. 5).

6. High Heels System

Special handling of high heeled shoes is required and this occurs in Model Preparation process 310 at state 585. If the avatar is wearing high heels, the body model must be pushed up on its toes. Animations that the avatar performs must also include this modified position. Pushing the model up on its toes requires that the model's skeletal animation system be used. Specifically, a bone animation can be performed that raises the model up onto its toes. This animation data must accompany the shoe model's geometry data so an application can perform the animation when it accesses the model. The graphics process defines a high heel animation that is only one frame long. Frame 0 is the foot in its normal position, and frame 1 is the foot in its raised position. Note that the term animation is used here in the sense that the model's skeletal structure is moved in order to place the avatar into a high heels position. This is not an animation that a user would observe the avatar executing, such as a walk cycle or dance. Rather, the avatar will appear in the high heeled position without the user observing any transition to that state. The animation can be defined inside any 3d modeling and animation software package used to build the 3d models. In the present implementation, the animation is exported and embedded along with the model's geometry to a file that can be read by a graphics application.

When an application accesses the model data by reading the exported file from disk, it detects that this animation is present. The high heeled position is then mixed with any and all other animations that the avatar may perform, or with any stance or pose the avatar may be in. Specifically, for each body animation or pose that is performed, the bone orientations for the high heels are substituted for the bone orientations that would normally be present. In certain embodiments, when a body animation is loaded onto an avatar, every keyframe or that animation is modified by mixing in the high heels animation data. This results in the avatar performing the animation while being raised on its toes.

7. Recurring Processes

Referring back to the game loop, FIG. 3, recurring processes start at decision state 312 and act on the body and clothing models after all layering, slicing, morph target adjustments, skin tone adjustments, and makeup adjustments have been applied. These will necessarily have been performed in the game loop as a result of either the initial loading of the avatar, or by event-driven requests by the user. The subsequent recurring processes start with the prepared nude model composed of separate body (sliced), eyes, mouth and eyelashes, in addition to separate clothing models (potentially sliced), hair and accessory models. At decision state 312, the process 300 determines if a body animation is triggered or occurring. If so, the process advances to state 314 where body animation data is processed to move the avatar, which is the conglomerate of all models just mentioned, in accordance with any prescribed animation be performed. At the completion of state 314 or if a body animation is not triggered, as determined at decision state 312, the process 300 then advances to state 316. At state 316, the triangles for models that have transparency are sorted in front to back order for transparency effects (see section ii below). The last act is to render all of the data in a specific order at state 318 so that transparency effects are properly processed and the right parts of the avatar and body are displayed or covered. In certain embodiments, the rendering order is as follows: body, eyes, mouth, clothes, hair and eyelashes. The game loop ends at state 322.

### i. Body Animations

Body animations (state 314 of Game Loop process 300) are performed via standard methods for 3D character animation. Information is provided from the animation files for moving the bones used in performing the body animation (these are standard skeletal bones used in 3D graphics). Additionally, the models themselves contain data which describes the weighting each bone has on each vertex in the model. Thus, when the bones move, the vertices of the model move in relation to the bones. Bones animation data is calculated every frame so that the models move and give the illusion of animation. Body animation calculations, which include calculating the positions of the vertices, are performed for all the deformed body components as well as the deformed clothing models and hair if a body animation is occurring. Therefore, the conglomerate model consisting of the body parts, clothing and hair animate synchronously and give the appearance of a cohesively moving, clothed avatar.

### ii. BSP Processing

As mentioned herein, some items, such as hair, contain random transparency regions and are typically static. Using a Binary Space Partition (BSP) tree is a standard graphics technique for drawing 3D objects triangles from back to front relative to a user's view, to ensure that the right parts of the object are shown and hidden for the view. Application of BSP processing is performed at state 316 of Game Loop process 300. Therefore, hair items are treated with a BSP back to front structure that encompasses the entire model. In contrast, clothing may contain random transparency regions, but during animation, regions of clothing move with respect to each other. For example, the avatar's forearm might block the view of the opposite forearm, and then move to block the view of the opposite bicep. This all depends on the specific animation and the camera perspective. Standard BSP back to front rendering for this situation does not work, since the BSP structure itself changes every frame. To circumvent this problem, the system combines standard BSP processing with coarse region sorting.

### iii. DirectX Rendering

In certain embodiments, DirectX rendering is performed by standard DirectX dynamic buffer procedures for speed at state 318 of Game Loop process 300. Specifically, for models requiring BSP front to back calculations, triangles are not sent to the renderer one at a time for processing. Rather, for each BSP tree, a front to back array of triangle indices are generated and the entire array is then sent to DirectX. This results in much faster rendering. As noted herein, any rendering software or system may be used in conjunction with the graphics process of the present system. Therefore, the exemplary use of DirectX as the rendering package should not be construed as limiting.

Systems and modules described herein may comprise software, firmware, hardware, or any combination(s) of software, firmware, or hardware suitable for the purposes described herein. Software and other modules may reside on servers, workstations, personal computers, computerized tablets, PDAs, and other electronic devices suitable for the purposes described herein.

Software and other modules may be accessible via local memory, via a network, via a browser or other application in an ASP context, or via other means suitable for the purposes described herein. Data structures described herein may comprise computer files, variables, programming arrays, programming structures, or any electronic information storage schemes or methods, or any combinations thereof, suitable for the purposes described herein. User interface elements described herein may comprise elements from graphical user interfaces, command line interfaces, and other interfaces suitable for the purposes described herein. Screenshots presented and described herein can be displayed differently as known in the art to input, access, change, manipulate, modify, alter, and work with information.

While the system and method have been described and illustrated in connection with preferred embodiments, many variations and modifications, as will be evident to those skilled in this art, may be made without departing from the spirit and scope of the system and method, and the system and method are thus not to be limited to the precise details of methodology or construction set forth above as such variations and modification are intended to be included within the scope of the system and method.

What is claimed is:

1. A method of correcting bleed-through for layered three dimensional (3D) models, the method comprising:
providing a 3D body model;
providing one or more 3D clothing items overlying the body model, wherein the clothing items can be layered; and
embedding at least one slicer object in the clothing items, wherein the slicer object removes areas of the underlying body model or underlying clothing items.

2. A method of changing three dimensional (3D) clothing models on a 3D body model so as to appear to be the original body model wearing new clothing, the method comprising:
providing one or more 3D clothing models for one or more parts of a 3D body model;
slicing the body model based on the location of the clothing model(s); and
displaying the sliced body model with the clothing model(s).

3. A method of testing for visual occlusion of layered three dimensional (3D) clothing models on a 3D body model, the method comprising:
providing one or more 3D clothing models overlying the body model, wherein the clothing models are layered;
comparing a set of 3D geometric extents for an inner layer clothing model against a set of 3D geometric extents of an outermost layer clothing model;
determining if one or more slicer polygons associated with the outermost layer clothing model intersect the inner layer clothing model if the inner layer clothing model is encapsulated by the outermost layer clothing model; and
excluding further processing of the inner layer clothing model if none of the slicer polygons associated with the outermost layer clothing model intersect the inner layer clothing model.

4. A method of changing three dimensional (3D) clothing models on a deformed 3D body model so as to appear to be the deformed body model wearing new clothing, the method comprising:
deforming a 3D body model;
storing the deformations of the body model;
providing one or more 3D clothing models for one or more parts of the 3D body model;
slicing an undeformed version of the body model based on the location of the clothing models;
applying the stored deformations to the sliced body model and the clothing models; and
displaying the deformed sliced body model with the clothing models.

5. The method of claim 4, wherein the deforming utilizes a system employing spatial influences.

6. The method of claim 5, wherein the system comprises a bone system.

7. A method of deforming a three dimensional (3D) body model, the method comprising:
providing a set of bones for the 3D body model, wherein the body model comprises a set of vertices;
assigning a weighting for each bone of the set of bones, wherein the weighting of a particular bone represents a spatial influence of the particular bone on a corresponding subset of the set of vertices;
storing the weighting for each of the bones;
obtaining an input for a deformation;
changing an orientation of at least one bone in response to the input; and
moving portions of the vertices corresponding to the at least one changed bone based on the stored weights so as to deform the body model.

8. The method of claim 7, wherein the spatial influences are dynamically calculated.

9. The method of claim 8, wherein a particular deformation is modified by changing properties associated with one or more bones of the set of bones.

10. The method of claim 9, wherein one of the properties comprises orientation.

11. The method of claim 8, wherein a new deformation is added by adding a new set of bones for the new deformation.

12. The method of claim 7, wherein obtaining an input for the deformation is via a user interface:

13. The method of claim 7, wherein bone orientation comprises one or more of translation, rotation and scale.

14. A method of deforming hair of a three dimensional (3D) body model, the method comprising:
deforming a face of a 3D body model based on a user input;
calculating a morph percentage of a possible total deformation of the face;
providing a set of hair bones for deforming a hair model associated with the body model; and
orienting the set of hair bones for the hair model corresponding to the morph percentage.

15. The method of claim 14, wherein the hair model comprises a set of vertices.

16. The method of claim 15, additionally comprising assigning a weighting for each bone of the set of hair bones, wherein the weighting of a particular bone represents a spatial influence of the particular bone on a corresponding subset of the set of vertices.

17. The method of claim 14, wherein deforming the hair model matches the hair model to a shape of the deformed face.

18. A method of deforming hair of a three dimensional (3D) body model, the method comprising:
providing at least one 3D clothing model for a 3D body model, wherein at least a portion of the at least one clothing model comprises a set of bones;
determining an outermost clothing model on the torso of the body model;
adding a hair deformer for a hair model associated with the body model if the outermost clothing model includes a set of bones; and
applying the hair deformer to move the hair model based on the outermost clothing model.

19. The method of claim 18, wherein applying the hair deformer comprises orienting hair bones corresponding to the hair deformer.

20. The method of claim 18, wherein applying the hair deformer comprises preventing intersection of the hair model and the outermost clothing model by moving the hair model.

21. The method of claim 19, wherein the hair bones comprise at least one bone behind the neck and shoulders of the body model, at least one bone in front of the right shoulder, at least one bone in front of the left shoulder, and at least one bone along the top of the shoulders.

22. A method of changing a skin tone of a three dimensional (3D) body model, the method comprising:
providing a 3D body model having a texture map including pixels having color, wherein a base texture map has a base skin tone color average;
obtaining a requested skin tone color;
calculating a difference between the requested skin tone color and the base skin tone color average;
weighting the difference, for each pixel in the texture map, by a distance in color space between a color of a pixel and the base skin tone color average; and
applying the weighted difference to each pixel in the texture map.

23. The method of claim 22, wherein the weighting comprises:
1.0−((Red_{new}−Red_{original})**2+(Green_{new}−Green_{original})**2+(Blue_{new}−Blue_{original})**2)/normalizer,
where the normalizer is a distance of the pixel color to a point in color space that is farthest from the base skin tone color average.

24. The method of claim 22, wherein obtaining the requested skin tone color is based on a user input.

25. The method of claim 22, wherein the difference is additionally weighted by a distance to pure white in color space so as to preserve highlights.

26. The method of claim 25, wherein the additional weighting comprises:
1.0−(((2^{N}−1)−Red_{light})**2+((2^{N}−1)−Green_{original})**2+(2^{N}−1)−Blue_{original})**2)/normalization factor,
where N is the number of bits representing one of red, green or blue and the normalization factor is equal to the distance from pure black to pure white in color space.

27. The method of claim 26, wherein the normalization factor is 195075.

28. The method of claim 26, wherein each pixel has 24 bit color.

29. A method of animating an eye blink for a three dimensional (3D) body model, the method comprising:
a) generating an eye blink animation for a morph target of a deformed eye shape feature of an eye model for a 3D body model, wherein the morph target is an extreme limit of a particular deformation;
b) determining a weight based on a percentage of deformation to the morph target for the deformed eye shape feature; and
c) assigning the weight to the eye blink animation of the eye shape feature.

30. The method of claim 29, additionally comprising:
providing an eye blink animation for an undeformed eye model of the 3D body model;
generating an eye blink animation for the undeformed eye model; and
deforming an eye shape feature of the eye model in response to a user input.

31. The method of claim 30, additionally comprising:
repeating a) through c) for any additional eye shape features selected by the user for deforming; and
blending the eye blink animation for the undeformed eye model with the eye blink animation of the deformed eye shape feature(s) in accordance with the weights to generate a combined eye blink animation.

32. The method of claim 29, additionally comprising preventing either a right eye or a left eye from blinking so as to produce a wink animation.

33. The method of claim 32, wherein the preventing additionally comprises designating a time from a start of a facial animation for the wink animation to occur.

34. The method of claim 30, wherein the deforming of an eye shape feature includes one of a rotating, scaling and general eye socket shape changing.

35. A method of correcting bleed-through for layered three dimensional (3D) models, the method comprising:
providing a 3D body model;
providing one or more 31) clothing items overlying the body model, wherein the clothing items are layered;
embedding at least one slicer object in the clothing items;
excluding from further processing inner layers of clothing that are visually occluded by outer layers of clothing, wherein occlusion is determined by complete encapsulation of an inner layer by an outer layer and when the outer layer slicer object(s) do not slice the inner layer; and
removing areas of the underlying body model or underlying clothing items via the slicer object(s).

36. A method of correcting bleed-through for layered three dimensional (3D) models, the method comprising:
providing a 3D body model;
providing one or more 3D clothing items overlying the body model, wherein the clothing items are layered and comprises vertices;
embedding at least one slicer object in the clothing items;
excluding from further processing inner layers of clothing that are visually occluded by outer layers of clothing, wherein occlusion is determined by complete encapsulation of an inner layer by an outer layer and when the outer layer slicer objects(s) do not slice the inner layer;
geometrically separating clothing layers by contracting vertices on inner layers of clothing that intersect the geometry of outer layers of clothing;
geometrically separating clothing layers by expanding vertices on outer layers of clothing that intersect the geometry of inner layers of clothing; and
removing areas of the underlying body model or underlying clothing items via the slicer object(s).

37. A method of changing three dimensional (3D) clothing models on a deformed 3D body model so as to appear to be the deformed body model wearing new clothing, the method comprising:
deforming a 31) body model;
storing the deformations of the body model;
providing one or more 3D clothing models for one or more parts of the 3D body model, wherein at least one slicer object is embedded in each of the clothing models;
excluding from further processing inner layers of clothing that are visually occluded by outer layers of clothing, wherein occlusion is determined by complete encapsulation of an inner layer by an outer layer and when the outer layer slicer object(s) do not slice the inner layer;
geometrically separating clothing layers by contracting vertices on inner layers of clothing that intersect the geometry of outer layers of clothing;
geometrically separating clothing layers by expanding vertices on outer layers of clothing that intersect the geometry of inner layers of clothing;
slicing an undeformed version of the body model based on the location of the clothing models;
slicing inner layers of undeformed clothing with outer layer slicer object(s) based on the location of the clothing models;
applying the stored deformations to the sliced body model and the clothing models; and
displaying the deformed sliced body model with the deformed clothing models.

38. The method of claim 37, wherein the deforming utilizes a bones structure.

39. A method of resolving intersections for layered three dimensional (3D) models, the method comprising:
providing a 3D body model;
providing 3D clothing items overlying the body model, wherein the clothing items are layered and comprise vertices;
geometrically separating clothing layers by expanding vertices on outer layers of clothing that intersect the geometry of inner layers of clothing;
geometrically separating clothing layers by adjusting vertices on outer layers of clothing to be at least a threshold distance from the geometry of inner layers of clothing; and
geometrically separating clothing layers by contracting vertices on inner layers of clothing that intersect the geometry of outer layers of clothing.

40. The method of claim 39, additionally comprising animating the 3D body model with the geometrically separated clothing layers, whereby bleed-through of the inner layers of clothing is substantially prevented during the animation.

41. A method of resolving intersections for layered three dimensional (3D) models, the method comprising:
providing a 3D body model;
providing one or more 3D clothing items overlying the body model, wherein the clothing items are layered and comprises vertices;
geometrically separating clothing layers by expanding vertices on an original outer layer of clothing that intersect the geometry of an original inner layer of clothing;
geometrically separating clothing layers by adjusting vertices on the original outer layer of clothing to be at least a threshold distance from the geometry of the original inner layer of clothing; and
geometrically separating clothing layers by contracting vertices on the original inner layer of clothing that intersect the geometry of the original outer layer of clothing.

42. The method of claim 41, additionally comprising animating the 3D body model with the geometrically separated clothing layers, whereby bleed-through of the original inner layer of clothing is prevented during the animation.

43. The method of claim 41, wherein geometrically separating clothing layers by expanding vertices on the original outer layer of clothing comprises:
expanding the original outer layer;
for each vertex on the original outer layer:
generating a line segment from the current vertex on the expanded outer layer to the original outer layer,
determining if the line segment intersects any polygons on the original inner layer, and
moving the current vertex of the original outer layer to a position outside of the intersected polygon if the line segment intersects any polygons.

44. The method of claim 41, wherein geometrically separating clothing layers by adjusting vertices on the original outer layer of clothing comprises:
for each vertex on the original outer layer:
generating a line segment from the current vertex on the original outer layer to another position,
identifying which polygon on the original inner layer is intersected by the line segment, and
adjusting the current vertex of the original outer layer to be at least a threshold distance from the identified polygon if the distance of the original outer layer vertex to the identified polygon is less than the threshold distance.

45. The method of claim 44, additionally comprising contracting the original outer layer so as to move at least a portion of the original outer layer in a direction substantially orthogonal to the surface of the 3D body model.

46. The method of claim 41, wherein geometrically separating clothing layers by contracting vertices on the original inner layer of clothing comprises:
contracting the original inner layer;
for each vertex on the original inner layer:
generating a line segment from the current vertex on the contracted inner layer to the original inner layer,
determining if the line segment intersects any polygons on the original outer layer, and
moving the current vertex of the original inner layer to a position inside of the intersected polygon if the line segment intersects any polygons.

47. A method of resolving intersections for layered three dimensional (3D) models, the method comprising:
providing a 3D body model;
providing one or more 3D clothing items overlying the body model, wherein the clothing items are layered and comprises vertices;
geometrically separating clothing layers by expanding vertices on an outer layer of clothing that intersect the geometry of an inner layer of clothing and by contracting vertices on the inner layer of clothing that intersect the geometry of the outer layer of clothing.
